(19) United States
(12) Patent Application Publication
(10) Pub. No.: US 2016/0143795 A1
(43) Pub. Date: May 26, 2016

(54) ERGONOMIC LIFTING AND LOWERING MECHANISM FOR APPARATUSES FOR ASSISTING A HANDICAPPED PERSON

(71) Applicants: Eli SCHWARTZ, Herzeliya (IL); Giora NIR, Herzeliya (IL)

(72) Inventors: Eli SCHWARTZ, Herzeliya (IL); Giora NIR, Herzeliya (IL)

(21) Appl. No.: 14/551,009

(22) Filed: Nov. 23, 2014

(51) Int. Cl. A61G 5/14; A47K 13/10; A61G 7/10

(52) U.S. Cl. CPC A61G 5/14; A61G 7/1007; A61G 7/109; A47K 13/10; A61G 2200/34

(57) ABSTRACT

An ergonomic, power-assisted lifting-lowering unit for lifting or lowering a user, such as a disabled person. The lifting-lowering unit includes a body-holder, adapted to firmly hold/support at least at one body member/section of the torso of the user; a lifting-lowering-mechanism; a motion and force transmitting mechanism; and a power activator. The lifting-lowering-mechanism includes a power actuator that is operatively engaged with the body-holder, at preconfigured locations. The power activator activates the power actuator to thereby set in motion the motion transmitting mechanism that causes the body-holder to move in a path closely approximating to the movement of the femur bones, or a in path parallel thereto, when the user is moving between a standing position and a sitting position, the knees being the proximal center of the pivotal motion of the femur bones of the user.

### CROSS REFERENCE TO RELATED APPLICATION

This application is a continuation in part of U.S. patent application Ser. No. 13/988,324, filed on May 17, 2013, and also claims the benefit of U.S. provisional application 61/988,975 filed on May 6, 2014, the disclosure of which are incorporated by reference for all purposes as if fully set forth herein.

### FIELD OF THE INVENTION

This invention relates to power assisted lifting/lowering apparatuses that enable lifting disabled persons and more particularly, the present invention relates to a power assisted ergonomic lifting/lowering apparatus including a lifting mechanism that facilitates lifting a person such that his/her feet are stationed on a supporting ground, the calves and the knees are also substantially stationary and the motion of the head of the femur bone, as a result of the lifting motion, is in a virtual radial path formed by pivoting about the knees, while the back of the person remains in a substantial upright posture.

### BACKGROUND OF THE INVENTION AND PRIOR ART

It is well known that individuals having certain handicaps, especially the elderly, have difficulties in moving between sitting and standing positions, for example, with no limitations, when using a toilet seat.

Prior art powered lifting/lowering systems suffer from a variety of setbacks. For example, EP0625347 discloses a lifting device for disabled persons, which comprises at least one height-adjustable lever arm with at least one suspension point for one end of a tensile element, which can be placed under the armpits of the persons to be lifted and/or transported. In order to ensure uniform transmission of forces upon the person during lifting or lowering and transporting it is proposed that the tensile element be a resilient tube, or sections of such a tube, which can be filled with a fluid.

In another example, EP2380543 discloses crane and cradle apparatus for wheelchairs, to support disabled persons affected by motor disabilities and obligate to live on a wheelchair. The device is connected to the rear side of a wheelchair, for the lateral transfer of the patient, characterized in: a telescopic section that is installed with brackets on a rear side of the wheelchair and that is manhandled through a winch by an assistant; a jib placed at the end of the upper element of the telescopic section, characterized by rotating motion, whose purpose is the lateral displacement of the patient; a stabilizing, placed on a rear side of the wheelchair, whose purpose is to support the structure during the lateral displacement of the patient; two swivel and removable front wheels, positioned sideways of the footboard, increasing the stability of the structure.

In yet another example, EP1165008 discloses an aid apparatus for raising a disable person from a sitting position to a standing position including a wheeled base in the form of a U-shaped frame with a post, which supports a lifting arm arrangement, to which can be attached a lifting sling, which surrounds at least partly the body of the person. The object is now to avoid that the person will be lifted in his armpits and also to make the lifting motion stable. The lifting arm arrangement therefore includes two arms, the free ends of which have a hook, in which a belt having four bands can be hooked on in such a way that the belt surrounds the person overlapped just under breast-high.

In yet another example, U.S. Pat. No. 6,119,287 discloses a disabled person transfer unit that includes a base supporting a motor actuated rotatable platform, and a frame is mounted on the platform for pivotally supporting a pair of motor actuated lift arms which carry forearm support pads and hand grips and/or a removable seat sling. The arms pivot to pick up a person either seated or lying down, and the person may stand on the platform. The platform is rotated to transfer the person after which the arms lower the person to a new position.

None of the prior art provides an ergonomic lifting/lowering apparatus that can lift the user such that no substantial physical effort is required of the user, while being lifted from sitting position to standing position.

Prior art toilet seats lifting devices also suffer from a variety of setbacks. For example, U.S. Pat. No. 5,848,447, given to Blair W. Lindsay, discloses a device for raising and lowering a toilet seat, in which the front end of the seat is pivotally affixed at the front end side of the seat and thereby, an elderly seating on the seat may slide forward before reaching a stable standing position.

U.S. Pat. No. 6,754,917, given to Delbert R. Rhoades, discloses a complex system which provides no forward movement of the seat and thereby does not facilitate movement of the toilet seat in a path that closely approximates the movement of the hips, buttocks, thighs, knees and lower legs which occurs when a person, being supported by the toilet seat, moves between a standing position and a sitting position.

To facilitate ergonomic design of an adult lifting/lowering apparatus, average adult anthropometric measurements are used. For example, in Nasa research data, available in http://msis.jsc.nasa.gov/sections/section03.htm, the following relevant data may be used for the design:

For men:
Knee height, sitting: 56.7 cm;
Buttock-knee length: 61.3 cm;
Buttock popliteal length: 51.2 cm;

For women:
Knee height, sitting: 45.6 cm;
Buttock-knee length: 53.3 cm;
Buttock popliteal length: 41.7 cm;

In another reference: “Ergonomics and Design A Reference Guide”, © 2006 Allsteel Inc., by Scott Openshaw et. al, available at: www.allsteeloffice.com/ergo the following relevant data may be used for the design:

For men:
(top of) Knee height, sitting: 58.9 cm;
Buttock-knee length: 61.8 cm;
Buttock popliteal length: 49.3 cm;
Popliteal height: 46.5 cm;

For women:
(top of) Knee height, sitting: 54.6 cm;
Buttock-knee length: 59.1 cm;
Buttock popliteal length: 42.8 cm;
Popliteal height: 42.0 cm.

The above anthropometric data is given by way of example only, and other sources may be used for designing an ergonomic lifting/lowering apparatus for lifting adults.

There is a need and it would be advantageous to have a power assisted lifting/lowering apparatuses, including power assisted toilet seat, providing a lifting and tilting structure that facilitates lifting and descending movements of the torso of a user, in a path that closely approximates the movement of the hips, buttocks, thighs, knees and lower legs, occurring when a person, being supported by the power assisted lifting/lowering apparatus, moves between a standing position and a sitting position. It would be further advantageous for the power assisted toilet seat to provide a mechanism for adjusting the height of the seat in the seats upper most position, to fit the seat's height to the height of the person using the power assisted toilet seat.

### SUMMARY OF THE INVENTION

By way of introduction, the principal intentions of the present invention include proving a power assisted ergonomic lifting/lowering apparatus including a lifting mechanism that facilitates lifting a person, such that his/her feet are stationed on supporting ground, the calves (lower legs, fibulas) and the knees are also substantially stationary and the motion of the pelvis, as a result of the lifting motion dictated by the power lifting mechanism, is in a virtual radial path formed by the head of femur, while pivoting about the knees and while the back of the person remains in a substantial upright posture (actually, every point of each femur/thigh is pivoting about the respective knee).

No physical effort is required from the user, while being lifted from sitting position to standing position. Substantially all the lifting force that is required to lift the user from a sitting position to standing position is provided by the power assisted ergonomic lifting/lowering apparatus of the present invention.

No effort is required to prepare the user before using an embodiment of a power assisted ergonomic lifting/lowering apparatus of the present invention. Furthermore, physical effort is required of the user facilitates changing the clothes of the user and hygienic services.

The power assisted ergonomic lifting/lowering apparatus of the present invention can be fitted to suit the user's dimensions and needs.

An aspect of the present invention is to provide a power assisted ergonomic lifting/lowering apparatus having an ergonomic pivoting mechanism. Generally, the power assisted ergonomic lifting/lowering apparatus assumes a design in which the pivoting mechanism, when activated, forms a path of radial motion that is substantially parallel to the radial motion of the thigh of an average sized person. Typically, with no limitations, the radial motion covers an angular path of 90°.

However, anthropometric measurements show that the dimension of the human body parts may vary on the one hand, but in general, maintain proportion between them. When designing the radius of motion of the ergonomic pivoting mechanism a higher than average is assumed for the femur. An aspect of the present invention is to provide a height limiting mechanism for limiting the lifting height of the seat, to fit to the height of the person using the power-assisted toilet seat. Thereby, when reaching the upper most position, as set by the height limiting mechanism, the thighs are aligned with the lower legs such that the user reaches a standing posture.

Since the back of the user remains substantially in upright posture, the virtual path of motion of the shoulders is substantially parallel to the radial motion of the user's pelvis, the hands of the user may comfortably remain on the handles, in front of his/her body, throughout the motion of the power-assisted toilet seat, providing further comfort and support to the user. Typically, with no limitations, the radial motion of a power-assisted toilet seat covers an angular path of less than 90° to prevent a disabled user the fall off forward, when moving from a sitting position to a standing position, and to assure that the user leans on the seat when moving from a standing position to a sitting position.

According to the teachings of the present invention there is provided an ergonomic lifting-lowering unit for lifting and/or lowering a user, such as a disabled person. The power-assisted lifting-lowering unit includes a body-holder adapted to firmly hold or support the torso of the user at least at one body member and/or body section of the torso, a lifting-lowering-mechanism, a motion and force transmitting mechanism, and a power activator. The lifting-lowering-mechanism includes at least one power actuator, wherein the power actuator is operatively engaged with the body-holder, at preconfigured locations, and a power providing member for operating the power actuator.

The power activator is in operational communication with the power actuator to thereby set in motion the motion transmitting mechanism that causes the body-holder to move in a path closely approximating to the movement of the femur bones, or a in path parallel thereto, when the user is moving between a standing position and a sitting position, the knees being the proximal center of the pivotal motion of the femur bones of the user.

Preferably, the ergonomic lifting-lowering unit further includes a height adjustment mechanism, adapted to adjust the path of motion that closely approximates the movement of the femur bones, to thereby adapt to the actual bodily dimensions of the user, including the height of the popliteal of the user.

Substantially all the lifting force that is required to lift a user from a sitting position to a standing position is provided by the lifting-mechanism and no physical effort is required from the user.

The body-holder may include a seat-support-assembly, adapted to support the buttocks of the user, when the user is moving between a standing position and a sitting position.

The body-holder may include a user-support-assembly having a pair of armpit-rest-units, adapted to support the armpits of the user, when the user is moving between a standing position and a sitting position.

The user-support-assembly may include a harness firmly accommodating selected sections of the torso of the user.

Optionally, the at least one power actuator is an elongated device having two ends, and wherein a first end is pivotally attached to a stationary frame, at a preconfigured location, and wherein the second end is pivotally attached to a member of the motion transmitting mechanism, at a preconfigured location.

Optionally, the at least one power actuator is a compound jackscrew, and wherein the power providing member is a motor that is rotatably connected to the compound jackscrew.

Optionally, the power providing member is selected from a group of power lifting-lowering-mechanisms including a pneumatic mechanism and a hydraulic mechanism.

Optionally, the power actuator is selected from a group of power actuator including a pneumatic cylinder and a hydraulic cylinder.

The motion transmitting mechanism of the ergonomic lifting-lowering may include at least one pair of radial-motion-creating-arms, wherein each the pair of radial-motion-creating-arms includes a lower-radial-motion-creating-arm, an upper-radial-motion-creating-arm, and a motion-conveying-member.

A rear end of the lower-radial-motion-creating-arms is pivotally attached to lower section of the motion-conveying-member, at a preconfigured location; and wherein a front end of the lower-radial-motion-creating-arm is pivotally attached to the top section of a stationary frame, at a preconfigured location.

A rear end of the upper-radial-motion-creating-arm is pivotally attached to a higher section of the motion-conveying-member, at a preconfigured location; and wherein a front end of the upper-radial-motion-creating-arm is pivotally attached to the stationary frame, at a preconfigured location disposed generally above the front end of the lower-radial-motion-creating-arm.

The power activator is pivotally attached to the upper-radial-motion-creating-arm, at a preconfigured location. When the power activator is activated, the motion-conveying-member moves in a path closely approximating to the movement of the femur bones, or in a path parallel thereto.

An aspect of the present invention is to provide an ergonomic power-assisted lifting-lowering apparatus including a lifting-lowering-assembly that including a pair of side-moving-assemblies (321), each having the power-assisted lifting-lowering unit, wherein the body-holder includes a pair of user-support-assemblies wherein body-holder is adapted to firmly support the armpits of the user.

The stationary frame is a stationary frame-assembly (360) includes a pair of vertically oriented side-frame-structures, each having an inner face and an external face, a front side and a rear side, and a vertically oriented front-frame-structure.

The frontal inner sides of the side-frame-structures are securely interconnected by the front-frame-structure, leaving an opened space at the rear of the stationary frame-assembly, to thereby facilitate accommodating the user between the side-frame-structures.

The lifting-lowering-assembly further includes a front-moving-structure, wherein the side-moving-assemblies are securely interconnected by the front-moving-structure, leaving an opened space at the rear of the lifting-lowering-assembly, to thereby facilitate accommodating the user between the side-moving-assemblies.

Each the power-assisted lifting-lowering units may include a motion-relay-unit, and an orientation-maintaining-arm (394), wherein each the user-support-assemblies includes an adjustable armpit-rest-unit, wherein each the user-support-assemblies is attached to respective the motion-relay-unit, and wherein a first end of the orientation-maintaining-arm is securely attached to the upper-radial-motion-creating-arm at a preconfigured location and the second end of the orientation-maintaining-arm is pivotally attached to the motion-relay-unit, at a preconfigured location, to thereby maintain the motion-relay-unit in a substantially constant spatial orientation, including when the user is moving between a standing position and a sitting position, such that respective the armpit-rest-unit is maintained in a substantially upright orientation.

Each the armpit-rest-unit may further include a hollow sleeve-unit, adapted to fittingly accommodate a sliding-arm, and a locking device, wherein the locking device is preconfigured to allow free upward movement of the sliding-arm inside the sleeve-unit, wherein when the locking device is in a locked state, the locking device is preconfigured to prevent downward movement of the sliding-arm inside the sleeve-unit.

The user-support-assembly may further include a horizontal-arm, extending sideways from the top end of the sliding-arm, wherein the horizontal-arm is securely attached thereto; and a hollow top-arm, extending upwardly from the other end of the horizontal-arm, wherein the top-arm is securely attached thereto, wherein the armpit-rest-unit is rotatably accommodated inside the top-arm and thereby, facilitating the armpit-rest-unit to comfortably adapt to the armpit of user.

The body-holder may further include a harness firmly accommodating selected sections of the torso of the user.

An aspect of the present invention is to provide a lifting-lowering-assembly including a pair of side-moving-assemblies (121), each having the power-assisted lifting-lowering unit, wherein the body-holder is a seat-support-assembly adapted to firmly support the buttocks and thighs of the user and wherein the stationary frame is a stationary frame-assembly (160), facilitated to securely attach to the top of a toilet seat bowl through the common bores conventionally used to attach a conventional toilet seat.

The frame-assembly includes interconnected stationary frame members adapted to embrace the toilet seat bowl; a U-shaped bowl-top sub-frame disposed substantially parallel to the top rim of the toilet seat bowl, wherein the two arms of the U-shaped bowl-top sub-frame are pointing towards the front of the toilet seat bowl; and a leg holder disposed at the front of the toilet seat bowl proximal and substantially parallel to the floor.

The lifting-lowering-assembly may further include U-shaped seat-support-panel, wherein the two arms of the U-shaped seat-support-panel are pointing towards the front of the toilet seat bowl, and side-walls, being the motion-conveying-member, wherein the U-shaped seat-support-panel is adapted to securely carry a conventional toilet seat, and wherein when the power activator is activated, the motion-conveying-member moves in a path closely approximating to the movement of the femur bones, or in a path parallel thereto.

Each of the power-assisted lifting-lowering units of the ergonomic power-assisted toilet seat may further include a back-support-plate, motion-relay-support-arms, and an orientation-maintaining-arm (194). The back-support-plate securely interconnects the motion-relay-support-arms, wherein a first end of the orientation-maintaining-arm is securely attached to the upper-radial-motion-creating-arm at a preconfigured location, and the second end of the orientation-maintaining-arm is pivotally attached to respective the motion-relay-support-arms, at a preconfigured location, to thereby maintain the back-support-plate in a substantially constant spatial orientation, including when the user is moving between a standing position and a sitting position, such that the back-support-plate is maintained in a substantially upright orientation.

The ergonomic power-assisted toilet seat may further include at least one arm-rest-assembly.

Optionally, the power activator is disposed at preconfigured location on each of the arm-rest-assemblies.

Optionally, when the U-shaped seat-support-panel moves between the standing position and the sitting position, the preconfigured location of the power activator remains conveniently accessible to the user.

Optionally, the at least one power actuator is a compound jackscrew, wherein the power providing member is a motor that is rotatably connected to the compound jackscrew wherein rotating the motor in a first direction, lifts the U-shaped seat-support-panel from the sitting position to the standing position, and wherein rotating the motor in a second direction, lowers the U-shaped seat-support-panel from the standing position to the sitting position.

The ergonomic power-assisted toilet seat may further include a height adjustment mechanism, adapted to adjust the path of motion that closely approximates the movement of the femur bones, to thereby adapt to the actual bodily dimensions of the user, including the height of the popliteal of the user.

The ergonomic power-assisted toilet seat may further include a feet-lifting-device for moving the legs and knees of a sitting person upwardly. The feet-lifting-device may include a lifting-tray, a fray-lifting mechanism, and a second power activator, wherein the tray-lifting mechanism is in operational communication with the lifting-tray; and wherein the second power activator is in operational communication with the tray-lifting mechanism.

Optionally, the tray-lifting mechanism includes a motion conveying bar, a second power actuator and a motor. Activating the second power activator activates the motor to rotatably activate the second-power actuator to thereby move the lifting-tray in a generally vertical direction.

Optionally, rotating the motor in a first direction, lifts the U-shaped seat-support-panel from the sitting position to the standing position, and wherein rotating the motor in a second direction, lowers the U-shaped seat-support-panel from the standing position to the sitting position.

### BRIEF DESCRIPTION OF THE DRAWINGS

The present invention will become fully understood from the detailed description given herein below and the accompanying drawings, which are given by way of illustration and example only and thus not limitative of the present invention, and wherein:

FIG. 1a is a front-isometric view illustration of a power-assisted ergonomic lifting/lowering apparatus for disabled persons, according to some embodiments of the present invention, wherein the power-assisted ergonomic lifting/lowering apparatus is shown in the lower most position.

FIG. 1b is a rear-isometric view illustration of the power-assisted ergonomic lifting/lowering apparatus, as shown in FIG. 1a.

FIG. 2a is a front-isometric view illustration of a power-assisted ergonomic lifting/lowering apparatus, used in conjunction with lifting a user, being seated on a bed, from the seating position to a standing position.

FIG. 2b is a rear-isometric view illustration of the power-assisted ergonomic lifting/lowering apparatus, as shown in FIG. 2a.

FIG. 3a, is a side view illustration of the power-assisted ergonomic lifting/lowering apparatus, illustrating the geometrical relationship to a user and the power-assisted ergonomic lifting/lowering apparatus, wherein the user is of average adult anthropometric measurements, wherein the user is in a seating position and wherein the side-frame-structures is remover for illustrative purposes only.

FIG. 3b is a side view illustration of the power-assisted ergonomic lifting/lowering apparatus, as shown in FIG. 2a, but the user is situated in an intermediate position between the sitting position and the standing position.

FIG. 3c is a side view illustration of the power-assisted ergonomic lifting/lowering apparatus, as shown in FIG. 2a, but the user is in a standing position.

FIG. 4a is a front-isometric view illustration of a frame-assembly if the power-assisted ergonomic lifting/lowering apparatus, as shown in FIG. 2a.

FIG. 4b is a rear-isometric view illustration of the frame-assembly shown in FIG. 4a.

FIG. 5a is a front-isometric view illustration of a lifting-lowering-assembly, as shown in FIG. 2a.

FIG. 5b is a rear-isometric view illustration of the lifting-lowering-assembly shown in FIG. 5a.

FIG. 6a is a side isometric view of a user-support-assembly, being part of the side-frame-structures, wherein the armpit-rest-unit is in the lower most position.

FIG. 6b is a rear-isometric view illustration of the user-support-assembly shown in FIG. 5a, wherein the armpit-rest-unit is in a raised position.

FIGS. 7a and 7b illustrate the swivel ability of the armpit-rest-unit inside the top-arm.

FIGS. 8a, 8b and 8c are side-top isometric views of the side-moving-assemblies, illustrating the pivotal ability of the user-support-assembly.

FIGS. 9a, 9b and 9c are top views of the side-moving-assemblies, as respectively shown in FIGS. 8a, 8b and 8c.

FIG. 10a illustrates a front-isometric view illustration of the lifting-lowering-assembly, the lifting-lowering-assembly being in an intermediate raised position.

FIG. 10b, illustrates the rear-isometric view illustration of the lifting-lowering-assembly, as shown in FIG. 10a.

FIG. 11a illustrates a front-isometric view illustration of the lifting-lowering-assembly, the lifting-lowering-assembly being in a standing position.

FIG. 11b illustrates the rear-isometric view illustration of the lifting-lowering-assembly, as shown in FIG. 11a.

FIG. 12a is a schematic illustration of a person in a standing posture.

12b is a schematic illustration of a person in a standing posture, wherein his/her body is schematically broken into moving body parts, including parts the\at typically pivot when moving between sitting and standing positions.

FIG. 12c is a schematic illustration of a person moving from standing position to sitting position, wherein his/her thigh has pivoted downwards by about 30°.

FIG. 12d is a schematic illustration of a person moving from standing position to sitting position, wherein his/her thigh has pivoted downwards by about 60°.

FIG. 12e is a schematic illustration of a person in a sitting posture.

FIG. 13 schematically shows an overlay of the positions of a person, when moving between sitting and standing positions.

FIG. 14 is a side-view illustration of the power-assisted ergonomic lifting/lowering apparatus, as shown in FIG. 3c, serving a first user.

FIG. 15 is a side view illustration of the power-assisted ergonomic lifting/lowering apparatus serving another user, having a smaller form then the first user shown in FIG. 14.

FIG. 16 is an isometric view illustration of an ergonomic, power-assisted ergonomic lifting/lowering apparatus serving a user, wherein the user-support-assembly further comprises a harness.

FIG. 17 is an isometric view illustration of an ergonomic, power-assisted toilet seat for disabled persons, according to embodiments of the present invention, wherein the power-assisted toilet seat is shown in the lower most position.

FIG. 18 is an isometric view illustration of an ergonomic, power-assisted toilet seat as in FIG. 17, wherein the power-assisted toilet seat further includes a feet lifting device.

FIG. 19a is a front view illustration of the power-assisted toilet seat, as shown in FIG. 17.

FIG. 19b is a side view illustration of the power-assisted toilet seat, as shown in FIG. 17.

FIG. 20 is an isometric view illustration of a power-assisted toilet seat, as shown in FIG. 17, wherein the power-assisted toilet seat is shown in an intermediate position.

FIG. 21a is a front view illustration of the power-assisted toilet seat, as shown in FIG. 20.

FIG. 21b is a side view illustration of the power-assisted toilet seat, as shown in FIG. 17.

FIG. 22 is an isometric view illustration of a power-assisted toilet seat, as shown in FIG. 17, wherein the power-assisted toilet seat is shown in the upper most position.

FIG. 23a is a front view illustration of the power-assisted toilet seat, as shown in FIG. 22.

FIG. 23b is a side view illustration of the power-assisted toilet seat, as shown in FIG. 22.

FIG. 24 is an isometric view illustration of the seat and seat support structure, and the pair of arm-rest-assemblies.

FIG. 25 is an isometric view illustration of the frame-assembly.

FIG. 26a is a side view illustration of the power-assisted toilet seat, as shown in FIG. 17, illustrating the geometrical relationship to a user and the toilet seat.

FIG. 26b is a side view illustration of the power-assisted toilet seat, as shown in FIG. 20, illustrating the geometrical relationship to a user and the toilet seat.

FIG. 26c is a side view illustration of the power-assisted toilet seat, as shown in FIG. 22, illustrating the geometrical relationship to a user and the toilet seat.

FIG. 27a a is side view illustration of a power-assisted toilet seat, as shown in FIG. 17, having a height-adjusting-mechanism, according to variations of the present invention.

FIG. 27b is a side view illustration of a power-assisted toilet seat, as shown in FIG. 22, having a height-adjusting-mechanism according to embodiments of the present invention.

FIG. 28a is an isometric view illustration of a power-assisted toilet seat, as shown in FIG. 17, having a feet lifting device being in a down position, according to some embodiments of the present invention.

FIG. 28b is an isometric view illustration of a power-assisted toilet seat, as shown in FIG. 22, having a feet lifting device being in an upper position, according to variations of the present invention.

FIG. 29a is a side view illustration of a power-assisted toilet seat, as shown in FIG. 28a, wherein the device for moving the legs and knees of a sitting person upwardly is in a down position.

FIG. 29b is a side view illustration of a power-assisted toilet seat, as shown in FIG. 28b, wherein the device for moving the legs and knees of a sitting person upwardly is in an upper position.

FIG. 29c is a side view illustration of a power-assisted toilet seat, as shown in FIG. 29b, wherein the device for moving the legs and knees of a sitting person upwardly is in an upper position, thereby bringing the person using the power-assisted toilet seat proximal to a squat position.

FIG. 30a is a bottom view illustration of a power-assisted toilet seat, as shown in FIG. 28a.

FIG. 30b is a bottom view illustration of a power-assisted toilet seat, as shown in FIG. 28b.

### DESCRIPTION OF THE PREFERRED EMBODIMENTS

Before explaining embodiments of the invention in detail, it is to be understood that the invention is not limited in its application to the details of construction and the arrangement of the components set forth in the host description or illustrated in the drawings.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

Meanings of technical and scientific terms used herein are to be commonly understood as to which the invention belongs, unless otherwise defined. The present invention can be implemented in the testing or practice with methods and materials equivalent or similar to those described herein.

It should be noted that orientation related descriptions such as “bottom”, “up”, “left”, “right”, front”, “rear”, “horizontal”, “vertical”, “lower”, “top” and the like, is made with reference to the posture of a person using a lifting/lowering apparatus of the present invention.

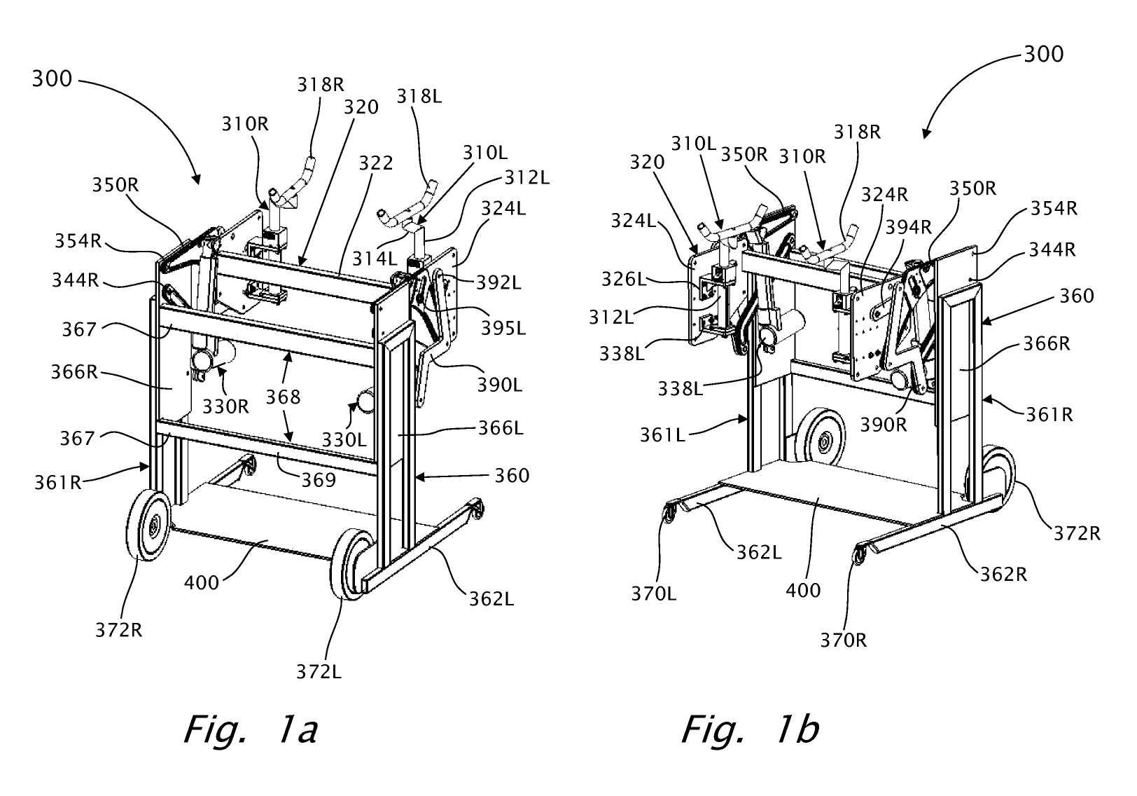

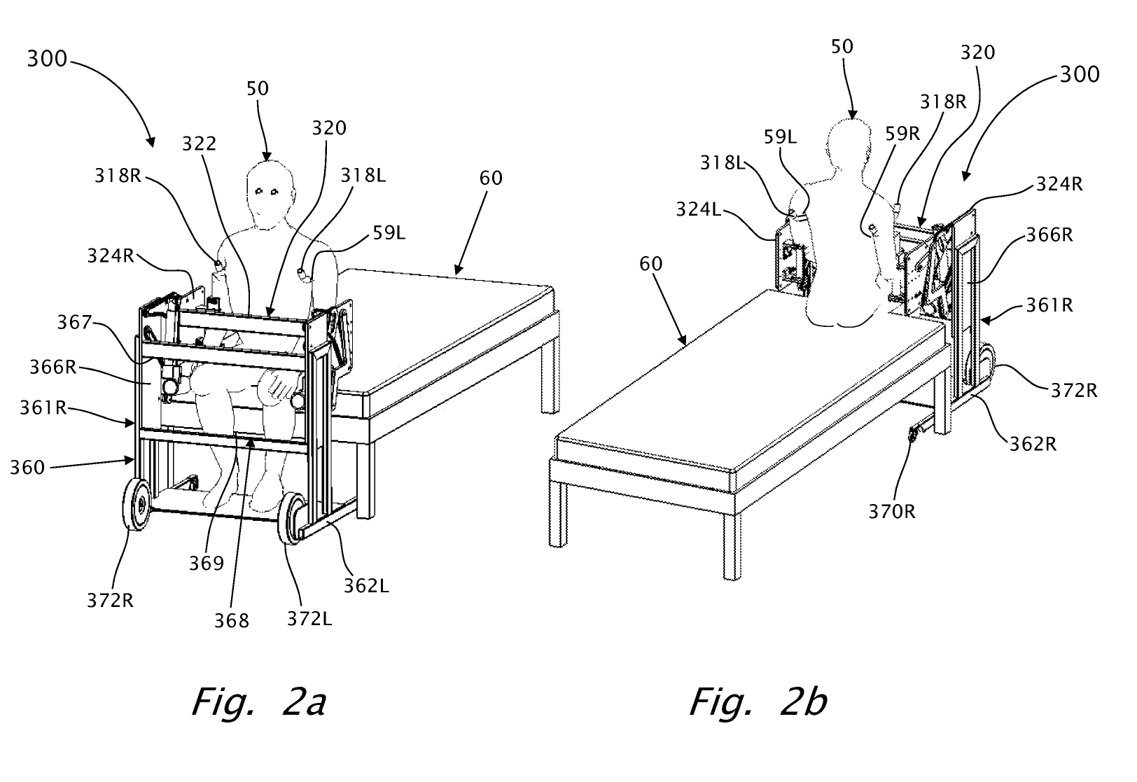

Reference is now made to the drawings. FIG. 1a is a front-isometric view illustration of a power-assisted ergonomic lifting/lowering apparatus 300 for disabled persons, according to some embodiments of the present invention, wherein power-assisted ergonomic lifting/lowering apparatus 300 is shown in the lower most position, in which position power-assisted ergonomic lifting/lowering apparatus 300 is configured to engage with a sitting user. FIG. 1b is a rear-isometric view illustration of power-assisted ergonomic lifting/lowering apparatus 300, as shown in FIG. 1a. FIG. 2a is a front-isometric view illustration of power-assisted ergonomic lifting/lowering apparatus 300, used in conjunction with lifting a user 50, being seated on a bed 60, from the seating position to a standing position. FIG. 2b is a rear-isometric view illustration of power-assisted ergonomic lifting/lowering apparatus 300, as shown in FIG. 2a.

Power-assisted ergonomic lifting/lowering apparatus 300 includes a stationary frame-assembly 360, a pair of user-support-assemblies 310 and a power-lifting-lowering-mechanism 330. Stationary frame-assembly 360 includes a pair of vertically oriented side-frame-structures 361R and 361L and a vertically oriented front-frame-structure 368. Lifting-lowering-assembly 320 includes a pair of sets of radial motion creating arms 340 and 350 and a motion-relay-member 390, being part of a four-bar mechanism design.

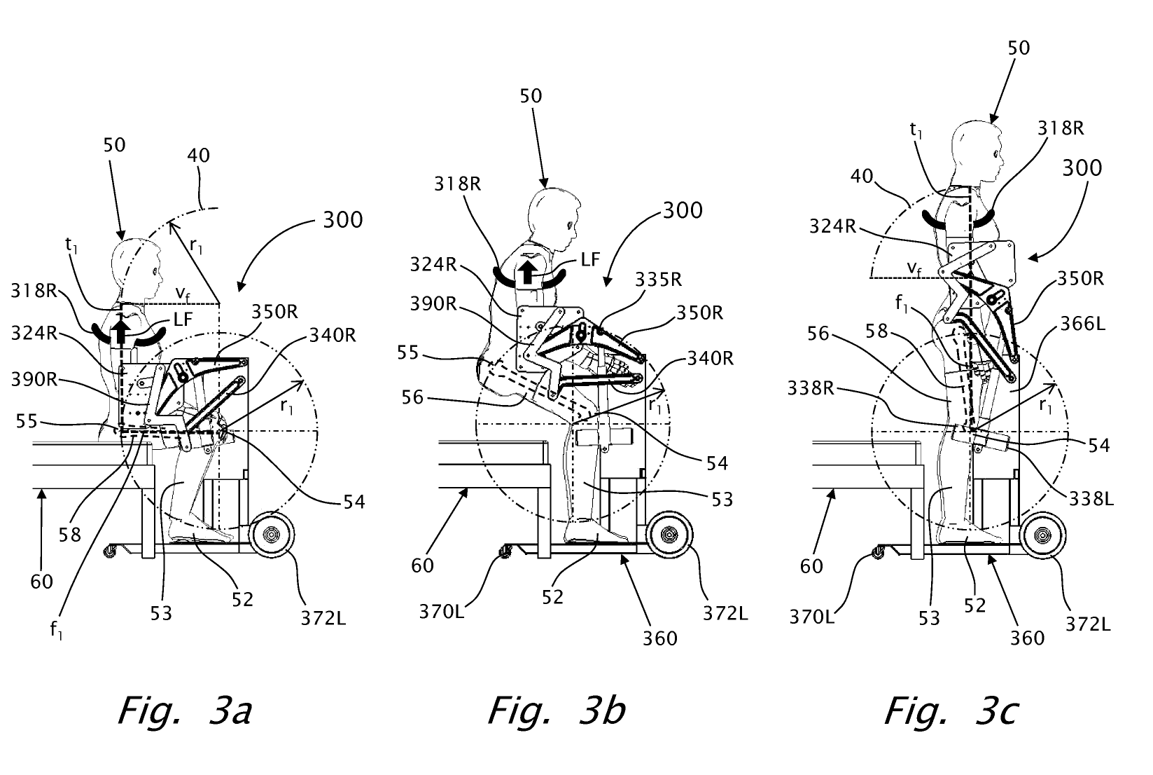

Reference is now made to FIG. 3a, a side view illustration of power-assisted ergonomic lifting/lowering apparatus 300, illustrating the geometrical relationship to a user 50 and power-assisted ergonomic lifting/lowering apparatus 300 of the present invention, wherein user 50 is of average adult anthropometric measurements, wherein user 50 is in a seating position and wherein side-frame-structures 361R is remover for illustrative purposes only; to FIG. 3b, a side view illustration of power-assisted ergonomic lifting/lowering apparatus 300, as shown in FIG. 2a, but user 50 is situated in an intermediate position between the sitting position and the standing position; and to FIG. 3c, a side view illustration of power-assisted ergonomic lifting/lowering apparatus 300, as shown in FIG. 2a, but user 50 is in a standing position.

To operate power-assisted ergonomic lifting/lowering apparatus 300, a user 50 (or another person) can use a wired control unit, a wireless control unit or any other electric switching operation known in the art.

In FIG. 3a, user 50 is shown in a sitting position and power-assisted ergonomic lifting/lowering apparatus 300 is in the lower most position. In FIG. 3c, user 50 is shown in a standing position, whereas power-assisted ergonomic lifting/lowering apparatus 300 is in the upper most position. It should be noted that the physical effort required from user 50 to reach the standing position is none or minimal. When lifting the torso of user 50, power-assisted ergonomic lifting/lowering apparatus 300 provides the force needed to lift the torso of user 50 in a preconfigured radial path, and thereby move the torso of user 50 by a preconfigure forward lateral distance v_{f}.

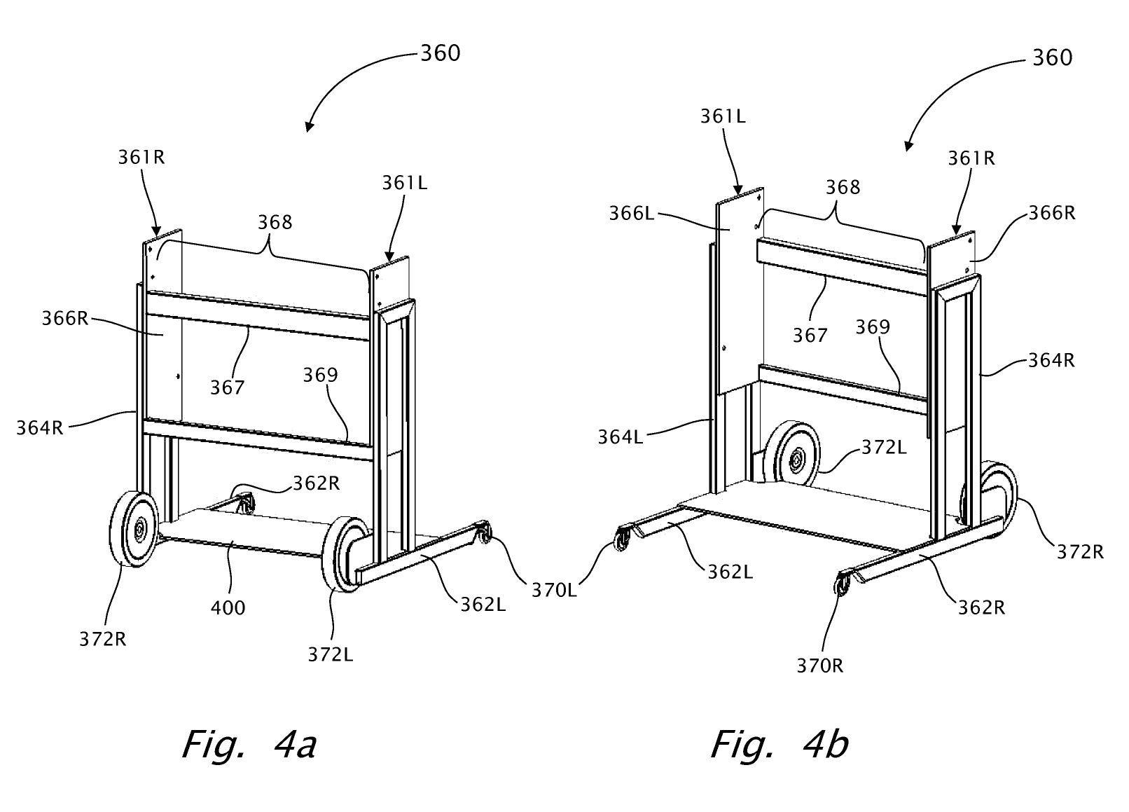

Reference is also made to FIG. 4a, a front-isometric view illustration of frame-assembly 360; and to FIG. 4b a rear-isometric view illustration of frame-assembly 360. Stationary frame-assembly 360 includes a pair of vertically oriented side-frame-structures 361R and 361L and a vertically oriented front-frame-structure 368. The frontal inner sides of side-frame-structures 361 are securely interconnected by front-frame-structure 368, leaving an opened space at the rear of stationary frame-assembly 360, to facilitate stationary frame-assembly 360 to accommodate a user 50 between side-frame-structures 361R and 361L. Typically, before being lifted, user 50 is stationary and in a sitting position, facing front-frame-structure 368. Stationary frame-assembly 360 may further include a set of wheels (370, 372) to facilitate positioning the rear side of power-assisted ergonomic lifting/lowering apparatus 300 proximal to user 50, when needed.

Each side-frame-structure 361 may include a generally horizontal bottom bar 362, wherein a generally vertical structure 364 extends upwardly therefrom. An inner-plate 366 may be securely attached to the internal side of each vertical structure 364. Inner-plate 366 may be integrated into vertical structure 364.

Front-frame-structure 368 may include at least one generally horizontal bar 367, or plate. Stationary frame-assembly 360, as shown in the figures, includes an upper horizontal bar 367 and a lower horizontal bar 369. Any other combination may be used. Front wheels 372 and rear wheels 370 are typically attached to respective horizontal bottom bars 362.

Stationary frame-assembly 360 may further include a standing-plate 410, to facilitate conveying user 50 after being lifted. Optionally, the height of standing-plate 410 can be adjusted.

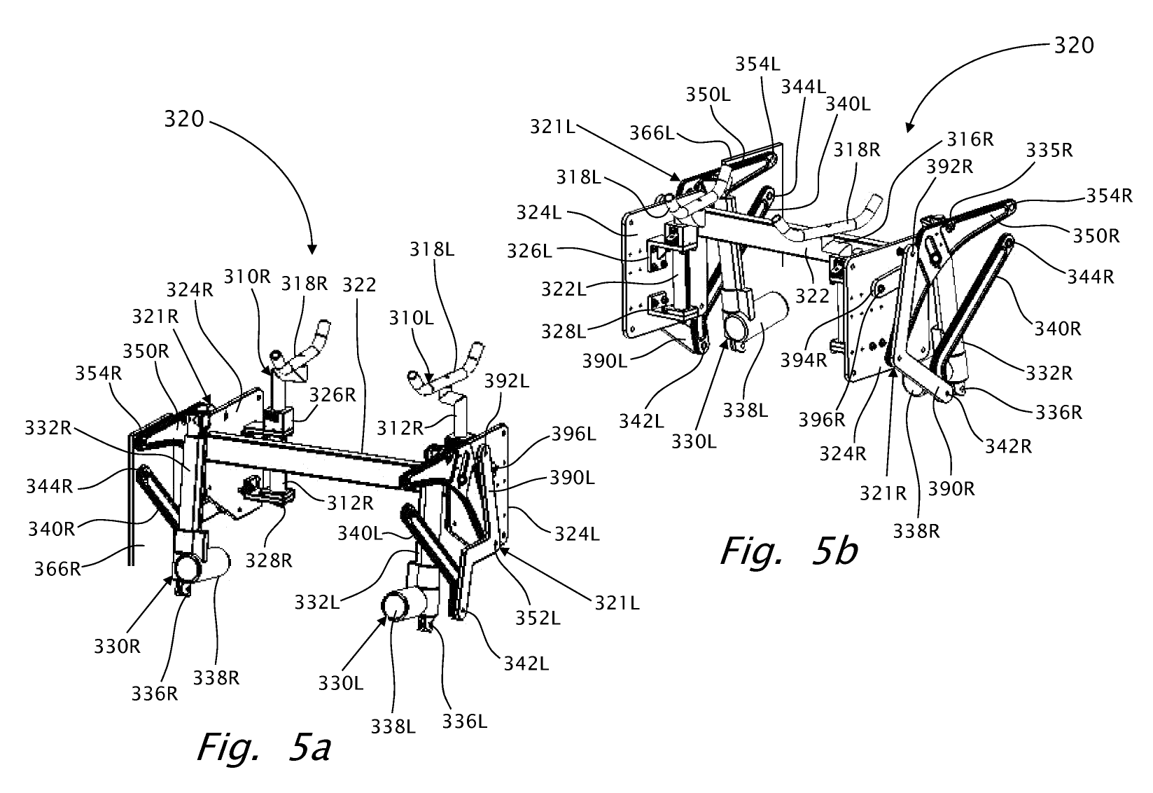

Lifting-lowering-assembly 320 is pivotally connected to side-frame-structures 361 at axes 344 and 354, respectively. FIG. 5a is a front-isometric view illustration of lifting-lowering-assembly 320. FIG. 5b is a rear-isometric view illustration of lifting-lowering-assembly 320. Lifting-lowering-assembly 320 includes a pair of vertically oriented side-moving-assemblies 321R and 321L and a front-moving-structure 322. The side-frame-structures 321 are securely interconnected by front-moving-structure 322, leaving an opening at the rear of lifting-lowering-assembly 320, to enable lifting-lowering-assembly 320 to accommodate a user between side-frame-structures 361R and 361L.

Front-moving-structure 322 may include at least one generally horizontal bar 322, or plate. Front-moving-structure 322, as shown in the figures, includes one horizontal bar 322. Hence, the terms front-moving-structure 322 and front-moving-bar 322 are used herein interchangeably, with no limitations.

Each side-moving-assembly 321 further includes a motion-relay-unit 324 and a user-support-assembly 310. Each side-moving-assembly 321 further includes a pivoting mechanism, wherein the formed path of radial motion that is substantially parallel to the virtual radial motion path formed by the head of femur 55, while pivoting about the knees and while the back of the person remains in a substantial upright posture. It is assumed that the lower leg 53 of user 50 remains generally in an upright position. Motion-relay-unit 324 receives the preconfigured radial motion from the pivoting mechanism and relays the received radial motion to the respective user-support-assembly 310. Motion-relay-unit 324 remains, during the radial motion of the pivoting mechanism, in the same spatial orientation, keeping the respective user-support-assembly 310 in a general upright orientation.

It should be noted that typically, moving-structure 322 securely interconnects the pair of planner motion-relay-units 324.

User-support-assembly 310 is designed to be positioned and support the respective armpit 59 of user 50 and lift user 50 when the powered lifting motion is activated. User-support-assemblies 310 are securely attached to the respective motion-relay-unit 324. Generally, motion-relay-units 324 are preconfigured to maintain the same spatial orientation throughout the motion path of side-moving-assemblies 321. Since, user-support-assemblies 310 are securely attached to the respective motion-relay-unit 324, user-support-assemblies 310 also maintain their spatial orientation.

Each pivoting mechanism uses a four-bar mechanism design to generate the radial motion, facilitating a preconfigured radial path of side-moving-assemblies 321. Each four-bar mechanism includes a lower-radial-motion-creating-arm 340 and an upper-radial-motion-creating-arm 350. At the rear end, lower-radial-motion-creating-arm 340 and an upper-radial-motion-creating-arm 350 are pivotally connected to a motion-relay-member 390, thereby fixating the distance between pivoting axis 342 of lower-radial-motion-creating-arm 340 and pivoting axis 352 of upper-radial-motion-creating-arm 350, while in motion. At the other end, the front end, lower-radial-motion-creating-arm 340 and an upper-radial-motion-creating-arm 350 are pivotally connected to the respective stationary inner-plate 366, at a preconfigured location, thereby fixating the distance between pivoting axis 344 of lower-radial-motion-creating-arm 340 and pivoting axis 354 of upper-radial-motion-creating-arm 350, while lower-radial-motion-creating-arm 340 and an upper-radial-motion-creating-arm 350 are in motion.

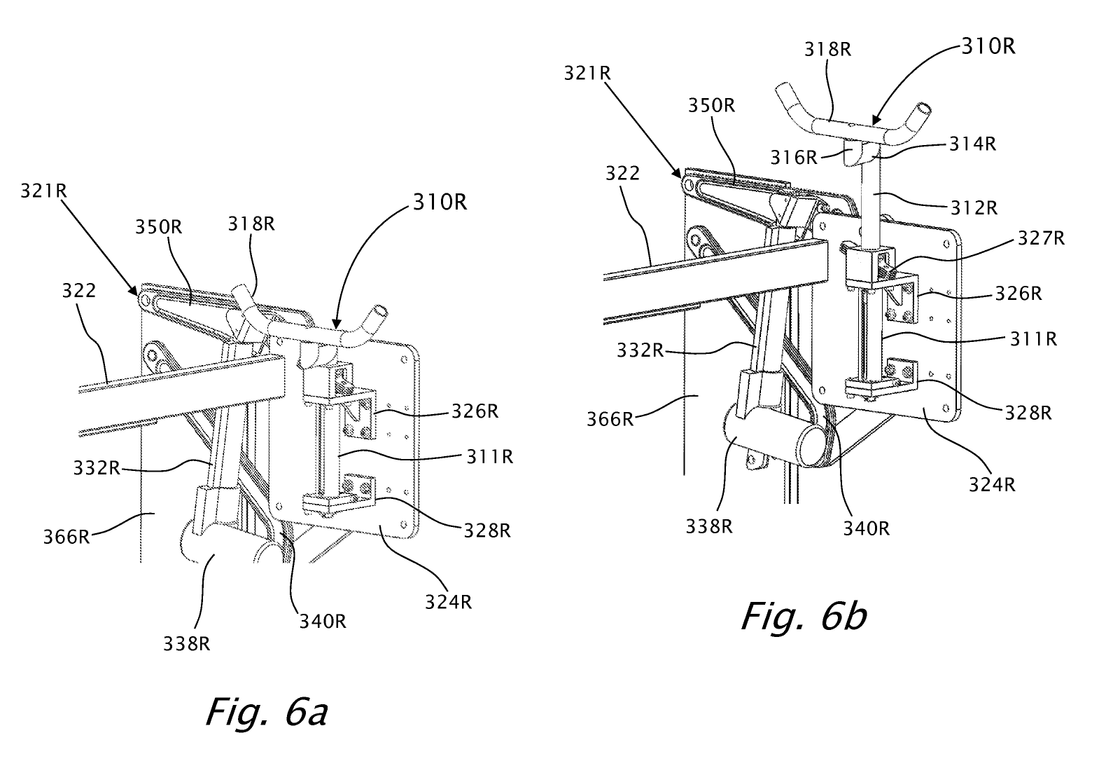

User-support-assemblies 310 are securely attached to the respective motion-relay-unit 324 by a fitted bearing 326R (upper-bearing) and/or a fitted bearing 328R (lower-bearing). Reference is also made to FIG. 6a, a side isometric view of user-support-assembly 310R, being part of side-frame-structures 361R, wherein an armpit-rest-unit 318R is in the lower most position; and to FIG. 6b, a side isometric view of user-support-assembly 310R, wherein an armpit-rest-unit 318R is in a raised position.

User-support-assembly 310 also includes a hollow sleeve-unit 311R adapted to fittingly accommodate a sliding-arm 312. Thereby, sliding-arm 312 can move up and down inside sleeve-unit 311R. A locking device, such as locking-washers-device 327, is used to allow free upward movement of sliding-arm 312 inside sleeve-unit 311R, but prevents unwanted downward movement of sliding-arm 312 inside sleeve-unit 311R. Unlocking sleeve-unit 311R facilitates downward movement of sliding-arm 312 inside sleeve-unit 311R.

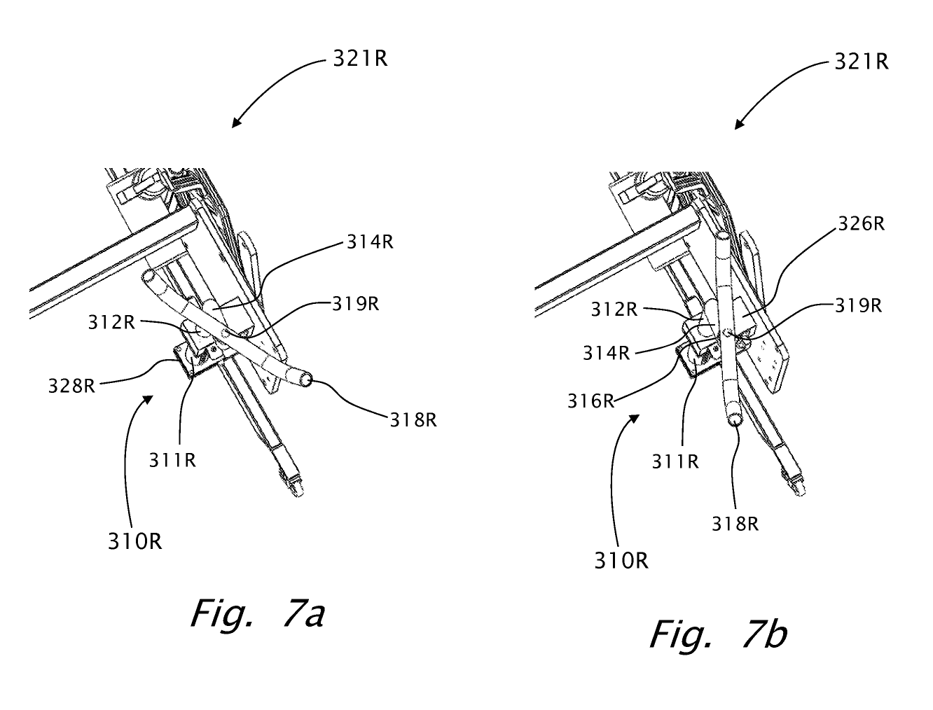

Preferably, user-support-assembly 310 further includes a horizontal-arm 314, extending sideways from the top end of sliding-arm 312, wherein horizontal-arm 314 is securely attached thereto. User-support-assembly 310 further includes a hollow top-arm 316, extending upwardly from the other end of horizontal-arm 314, wherein top-arm 316 is securely attached thereto. User-support-assembly 310 further includes an armpit-rest-unit 318, rotatably accommodated inside top-arm 316 and thereby, facilitating armpit-rest-unit 318 to comfortably adapt to the armpit 59 of user 50. Reference is also made to FIGS. 7a and 7b, illustrating the swivel ability, about axis 319, of armpit-rest-unit 318 inside top-arm 316.

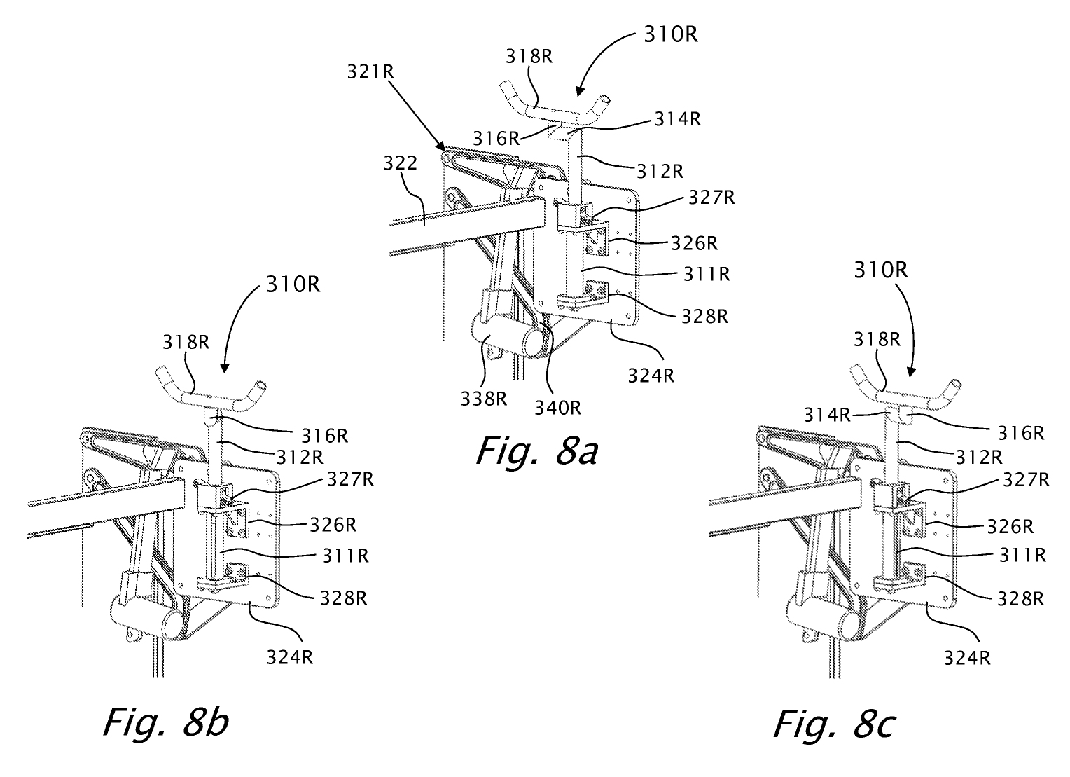

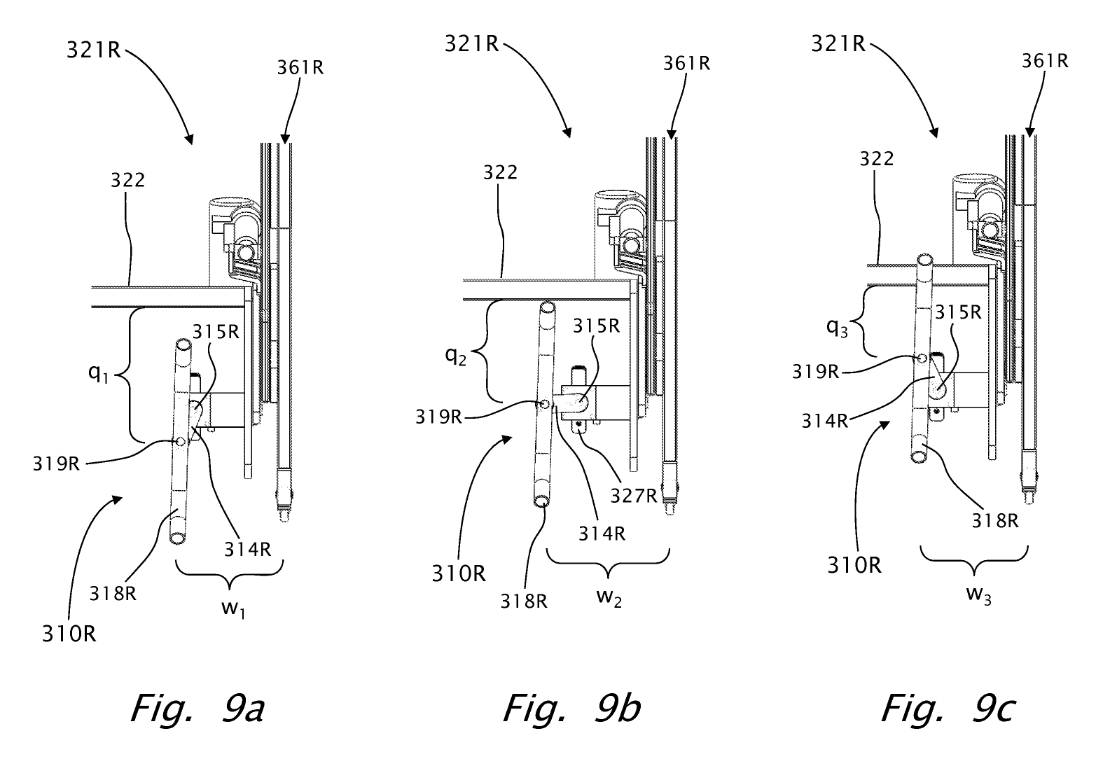

Reference is also made to FIGS. 8a, 8b and 8c, side-top isometric views of side-moving-assemblies 321, illustrating the pivotal ability, about axis 315, of user-support-assembly 310 to thereby adapt the distance between armpit-rest-unit 318R and armpit-rest-unit 318L to the distance between the armpits 59 of user 50. FIGS. 9a, 9b and 9c, are top views of side-moving-assemblies 321, as respectively shown in FIGS. 8a, 8b and 8c. Horizontal-arm 314 displaces rotational axis 319 of armpit-rest-unit 318, with respect to axis 315 of sliding-arm 312. Hence, when rotating sliding-arms 312 inwardly, as shown for example in FIGS. 8b and 9b, the distance stance between armpit-rest-unit 318R and armpit-rest-unit 318L is reduced, and vice versa: when rotating sliding-arms 312 inwardly, as shown for example in FIGS. 8b and 9b, the distance between armpit-rest-unit 318R and armpit-rest-unit 318L is increased.

Hence, the pivotal ability of rotating sliding-arms 312 facilitates adjustment of the distance between armpit-rest-unit 318R and armpit-rest-unit 318L to adjust to comfortably fit into armpits 59 of user 50. It can be seen in FIGS. 9a and 9b that distance w₁ is smaller than distance w₂, as axis 319R in FIG. 9b is disposed further away from side-frame-structures 361R than axis 319R in FIG. 9a is.

Furthermore, while the distances w₁ and w₂ are substantially equal, it can be seen in FIGS. 9a and 9c that axis 319R in FIG. 9a is disposed further away from front-moving-structure 322, at a distance q₁, than axis 319R in FIG. 9a is, at a distance q₃. Therefore, the position of axis 319R with respect to front-moving-structure 322, as seen in FIG. 9c, fits a thinner user than the position of axis 319R with respect to front-moving-structure 322, as seen in FIG. 9a.

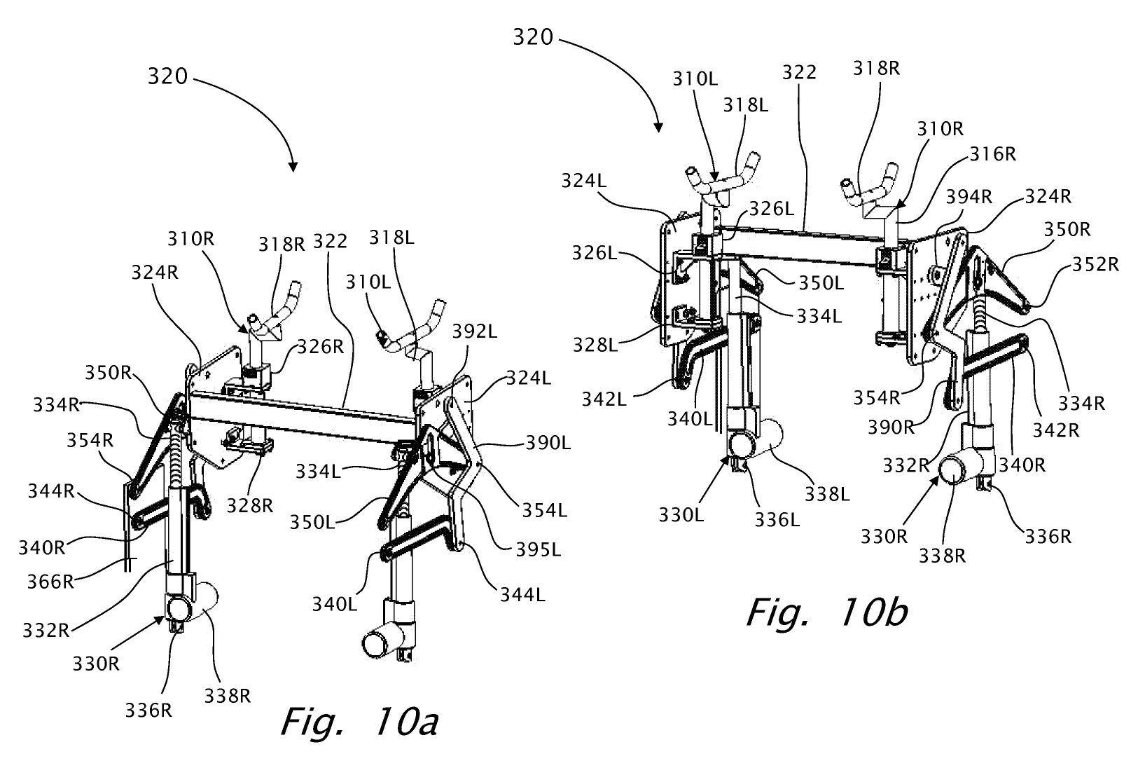

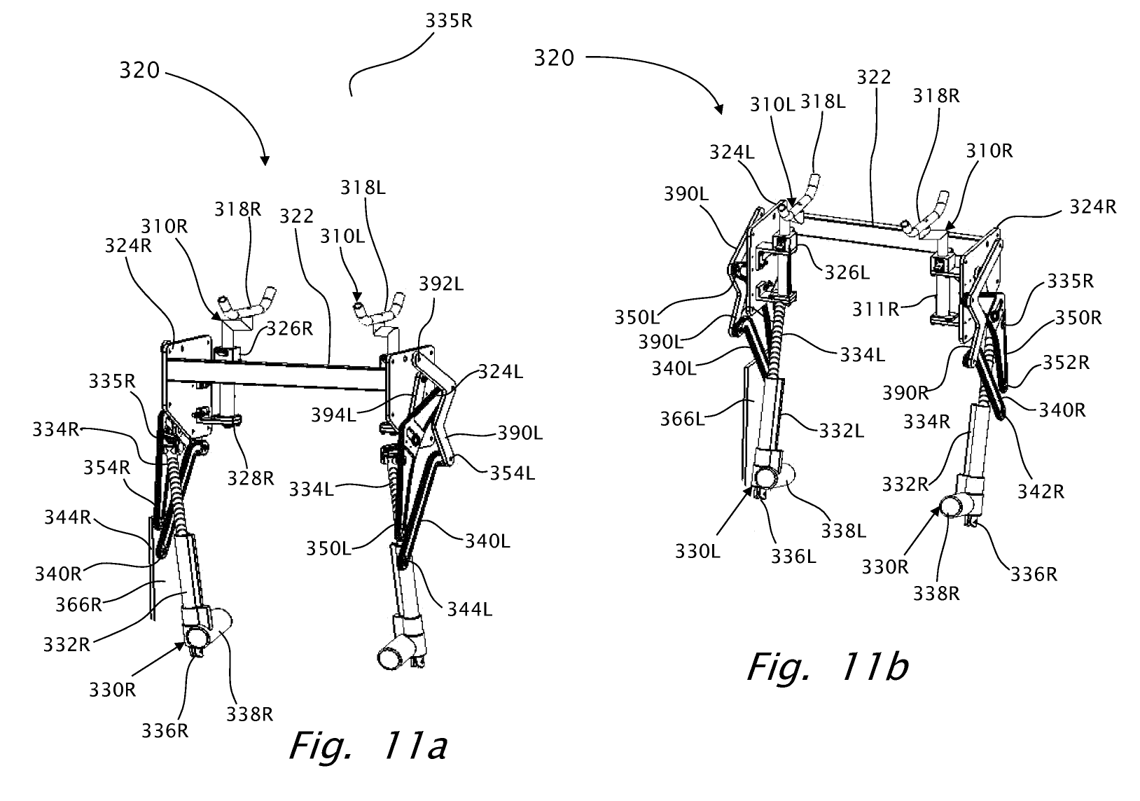

Reference is also made to FIG. 10a, illustrating a front-isometric view illustration of lifting-lowering-assembly 320, lifting-lowering-assembly 320 being in an intermediate raised position; to FIG. 10b, illustrating a rear-isometric view illustration of lifting-lowering-assembly 320, as shown in FIG. 10a; to FIG. 11a, illustrating a front-isometric view illustration of lifting-lowering-assembly 320, lifting-lowering-assembly 320 being in a standing position; and to FIG. 11b, illustrating a rear-isometric view illustration of lifting-lowering-assembly 320, as shown in FIG. 11a.

Side-moving-assemblies 321 are set in motion by activating one or more power-lifting-lowering-mechanisms 330, as shown by way of example in the figures. Each respective power-lifting-lowering-mechanism 330 includes a power actuator such as, with no limitations, a generally vertical compound jackscrew 334 that is preconfigured to push the side-moving-assemblies 321 in generally upward and forward directions, and to facilitate downwards and backwards motion directions of side-moving-assemblies 321.

Each respective power-lifting-lowering-mechanism 330 is pivotally connected to the respective stationary inner-plate 366, at a preconfigured location. Each power-lifting-lowering-mechanism 330 further includes an electric motor 338 powering the respective jackscrew 334 that is optionally controlled by a computerized feedback type circuitry for manually selectable or preprogrammed motion of side-moving-assemblies 321. Each jackscrew 334 is protected by a respective housing 332 and is coupled to operate therewith. Each of the electric motors, 338R and/or 338L, is rotatably connected to a respective jackscrew 334. Electric motor 338 is preferably a low voltage DC or AC motor, thereby facilitating easy switching from rotating the jackscrew 334 forward to rotating the jackscrew 334 backward. It should be noted that the jackscrew mechanism is provided by way of example only, and other power lifting-lowering-mechanisms, such as pneumatic or hydraulic mechanisms, may be used.

The lower end of each housing 332 of the respective power-lifting-lowering-mechanisms 330 is pivotally connected, at a preconfigured location, to the respective inner-plate 366 (vertical structure 364), at a lower section of that inner-plate 366, wherein the pivoting motion is facilitated about a respective axis 336. The upper end of the jackscrew housing 332 of each of the power-lifting-lowering-mechanisms 330 is pivotally connected to the respective upper-radial-motion-creating-arm 350, at a preconfigured location proximal to the middle of that conveying arm 350, wherein the pivoting motion is facilitated about a respective axis 335. Axis 336, being stationary, facilitates jackscrew 334 to move upper-radial-motion-creating-arm 350, thereby set the four-arms mechanism in motion, and thereby convey the lifting force FD (see FIGS. 3a and 3b) to user-support-assembly 310.

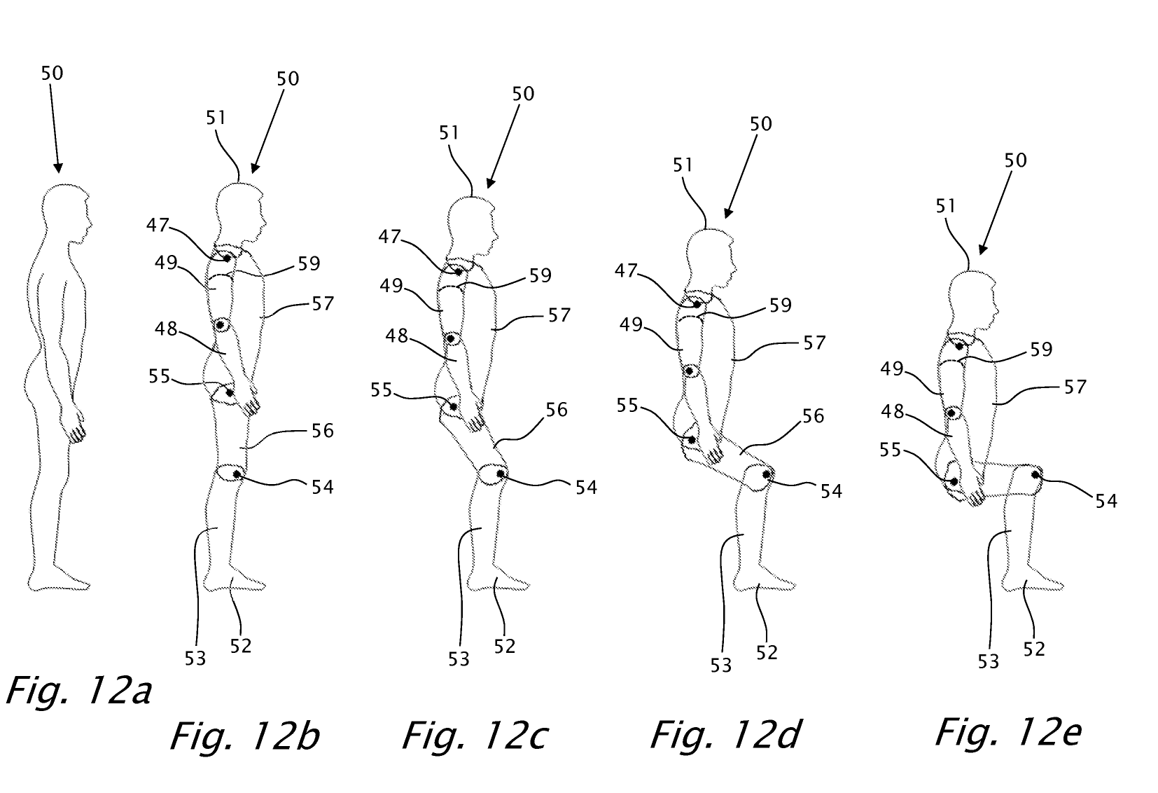

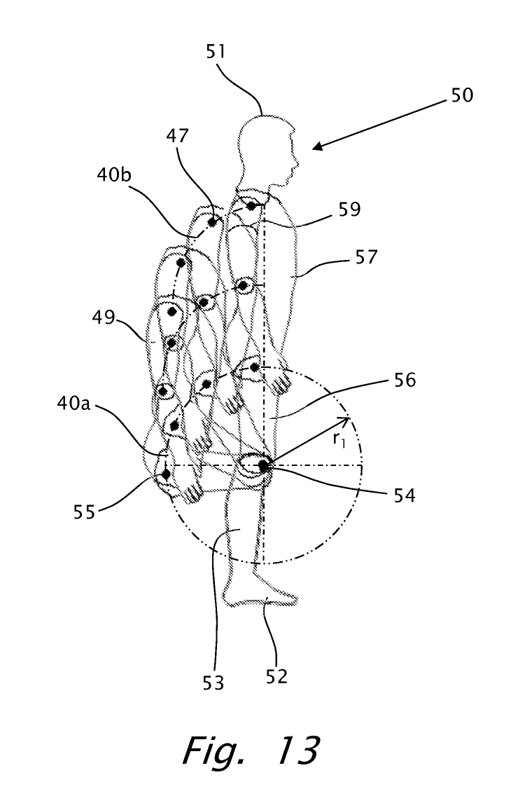

Reference is now made to FIG. 12a, schematically showing a person 50 in a standing posture; to FIG. 12b, schematically showing a person 50 in a standing posture, wherein his/her body is schematically broken into moving body parts, including parts the\at typically pivot when moving between sitting and standing positions; to FIG. 12c, schematically showing a person 50 moving from standing position to sitting position, wherein his/her thigh 56 has pivoted downwards by about 30°; to FIG. 12d, schematically showing a person 50 moving from standing position to sitting position, wherein his/her thigh 56 has pivoted downwards by about 60°; and to FIG. 12e, schematically showing a person 50 in a sitting posture. Reference is also made to FIG. 13, schematically showing an overlay of the positions of person 50, when moving between sitting and standing positions.

The parts of shown body parts of person 50 are head 51, foot 52, lower-leg 53, knee 54, head of femur 55, thigh 56, torso 57, femur bone 58, armpit 59, forearm 48 and upper arm 49 and shoulder 47.

It can be observed when person 50 is moving between sitting and standing positions, his/her thigh 56 pivots about his/her knee 54, wherein knee 54 remains generally in a steady spatial position, and so is the torso 57 of user 50. It can be further observed that the path 40a, being a quadrant, that the head of femur 55 is performing substantially parallel to the path 40b of that the shoulder 47 is performing. This applies the every point in the buttock of user 50 and his/her torso 57, including his/her armpit 59.

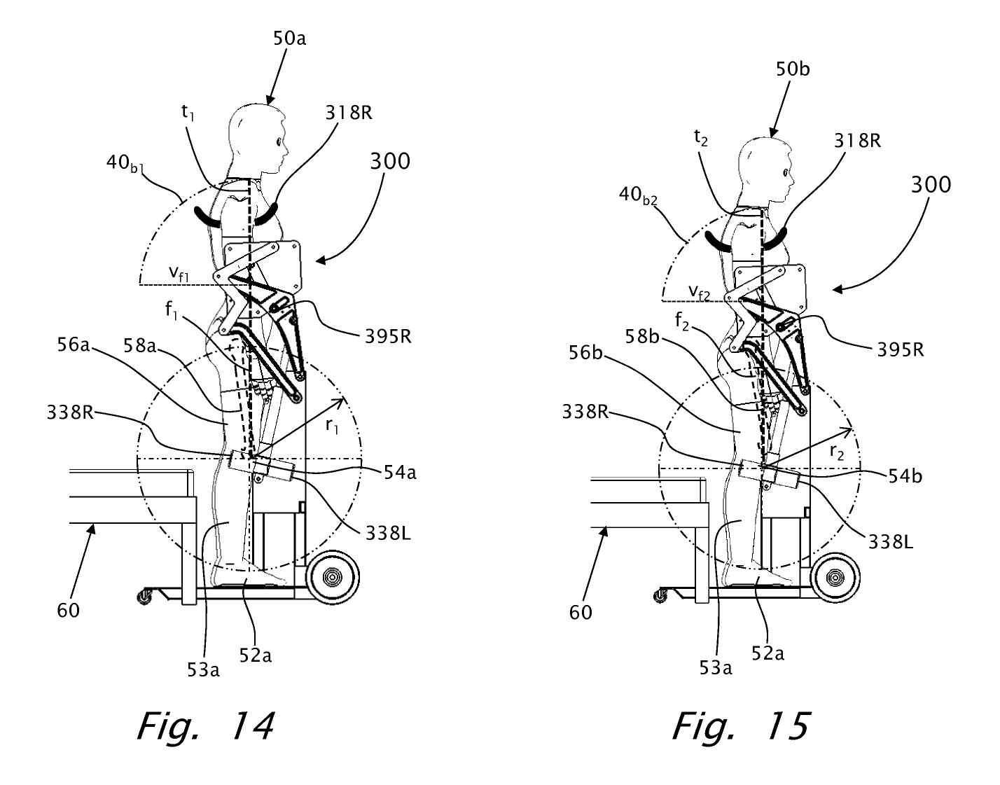

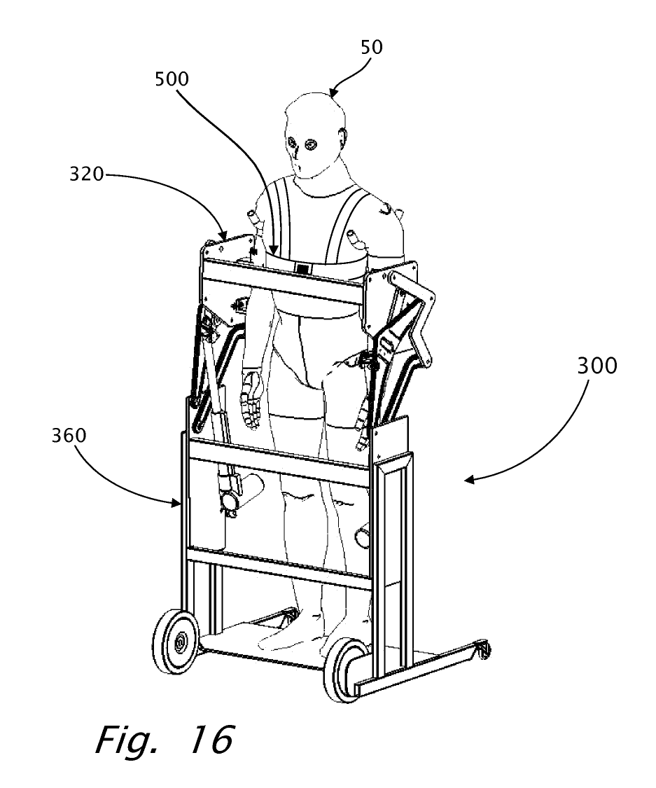

Preferably, power-lifting-lowering-mechanism 330 further includes a height limiting mechanism, to limit the motion distance of jackscrew 334 with respect to housing 332. Thereby, the lifting height can be adapted to the thigh (femur) 56 length of a particular user 50. Reference is now made to FIG. 14, illustrating a side view illustration of power-assisted ergonomic lifting/lowering apparatus 300, as shown in FIG. 3c, serving a user 50a. Reference is also made to FIG. 15, illustrating a side view illustration of power-assisted ergonomic lifting/lowering apparatus 300, serving a user 50b having a smaller form then user 50a. User 50a has a femur length of f₁ and user 50b a femur length of f₂ wherein f₁>f₂. User 50a has a torso 57 height of t₁ and user 50b a torso 57 height of t₂ wherein t₁>t₂.

Since the objective is to bring either user 50 to a standing position, it is noted that the radial motion path that is required of lifting-lowering-assembly 320 to perform path 40_{b1}, having a radius r₁, and the radial motion path that is required of lifting-lowering-assembly 320 to perform path 40_{b2}, having a radius r₂, wherein the length of path 40_{b1} is greater than the length of path 40_{b2}. Hence, the forward lateral distance v_{f1} that the torso 57 of user 50a has to be move is equal to radius r₁, and the forward lateral distance v_{f2} that the torso 57 of user 50b has to be move is equal to radius r₂. This also defines the forward lateral distance that the pair of armpit-rest-units 318 needs to be moved. The forward lateral distance v_{f} can be adjusted for each user 50 by limiting the lifting distance of jackscrew 334, by using a height limiting mechanism.

Typically, a power-lifting-lowering-mechanism 330, having a jackscrew 334 (or any other moving power rod) also includes a moving nut (not shown) that activates a micro-switch at the preconfigured motion ends, to thereby deactivate the motor. According to the present invention, at least the top-end micro-switch can be activated by external programming, to thereby provide a height limiting mechanism for adapting the forward lateral distance v_{f} to the users femur length.

It is an aspect of the present invention to maintain each respective motion-relay-unit 324, during the radial motion of the pivoting mechanism, in the same spatial orientation, such that the respective user-support-assembly 310 is maintained in a substantially upright orientation. Thereby, providing comfort to user 50 and facilitating the back of user 50 to remain generally in upright posture. To substantially maintain the spatial orientation of a motion-relay-unit 324, another orientation-maintaining-arm 394 is introduced. At a first end, orientation-maintaining-arm 394 is securely attached to upper-radial-motion-creating-arm 350 at a preconfigured location 395 (see, for example, FIGS. 1a, 10a and 14), proximal to the middle of upper-radial-motion-creating-arm 350. At the other end, orientation-maintaining-arm 394 is pivotally attached to motion-relay-unit 324, at a preconfigured location, wherein the pivoting motion is facilitated about axis 396 (see FIG. 5b). Furthermore, motion-relay-member 390 is also pivotally attached to motion-relay-unit 324, at a preconfigured location, wherein the pivoting motion is facilitated about axis 392 (see, for example, FIGS. 5a and 5b).

It is an aspect of the present invention to provide an ergonomic power-assisted toilet seat that utilized a lifting assembly that is similar to lifting-lowering-assembly 320, wherein the toilet lifting assembly is pivotally connected to a stationary frame structure that is securely attached to a conventional toilet seat.

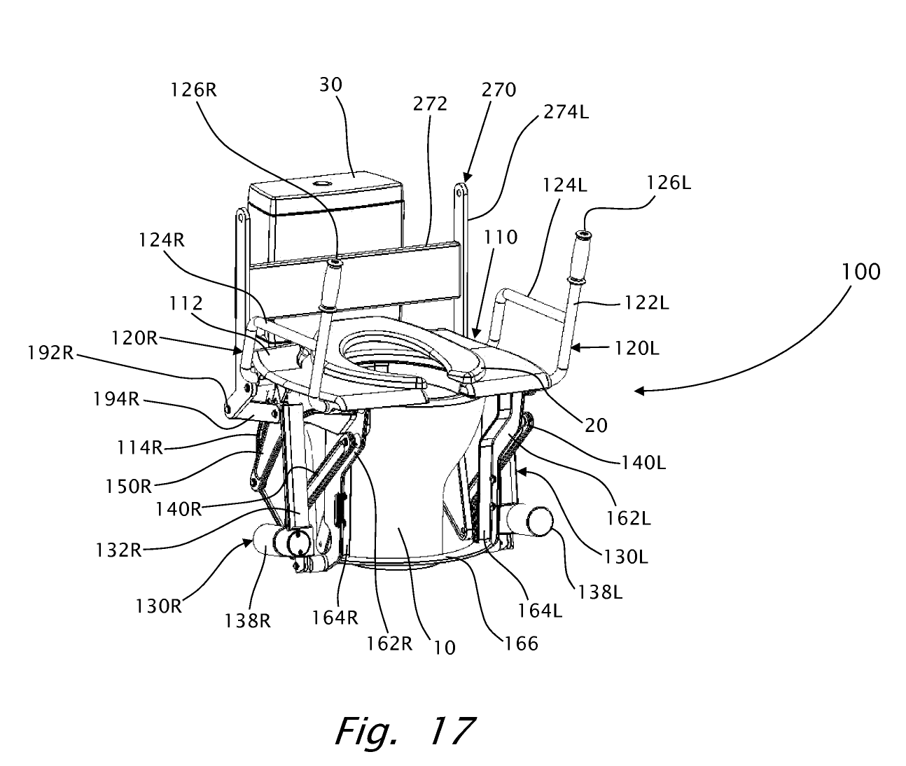

FIG. 16 is an isometric view illustration of an ergonomic, power-assisted ergonomic lifting/lowering apparatus 300 serving a user 50, wherein lifting-lowering-assembly 320 further comprises a harness 500. Harness 500 may distribute the lifting pressure points to multiple locations and thereby ease the lifting pressure upon the user's torso.

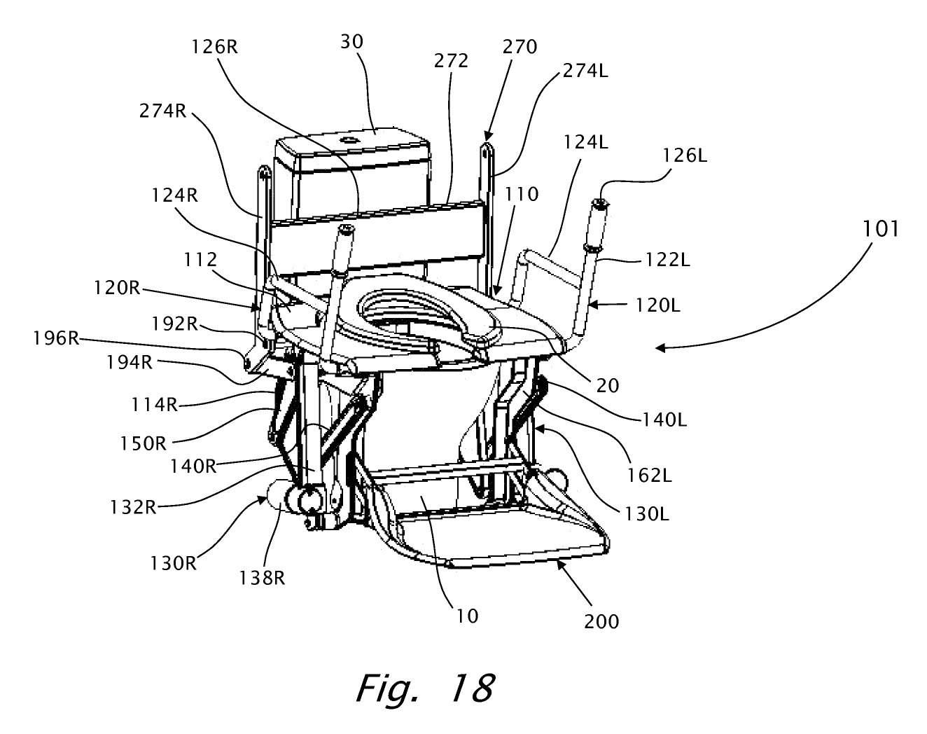

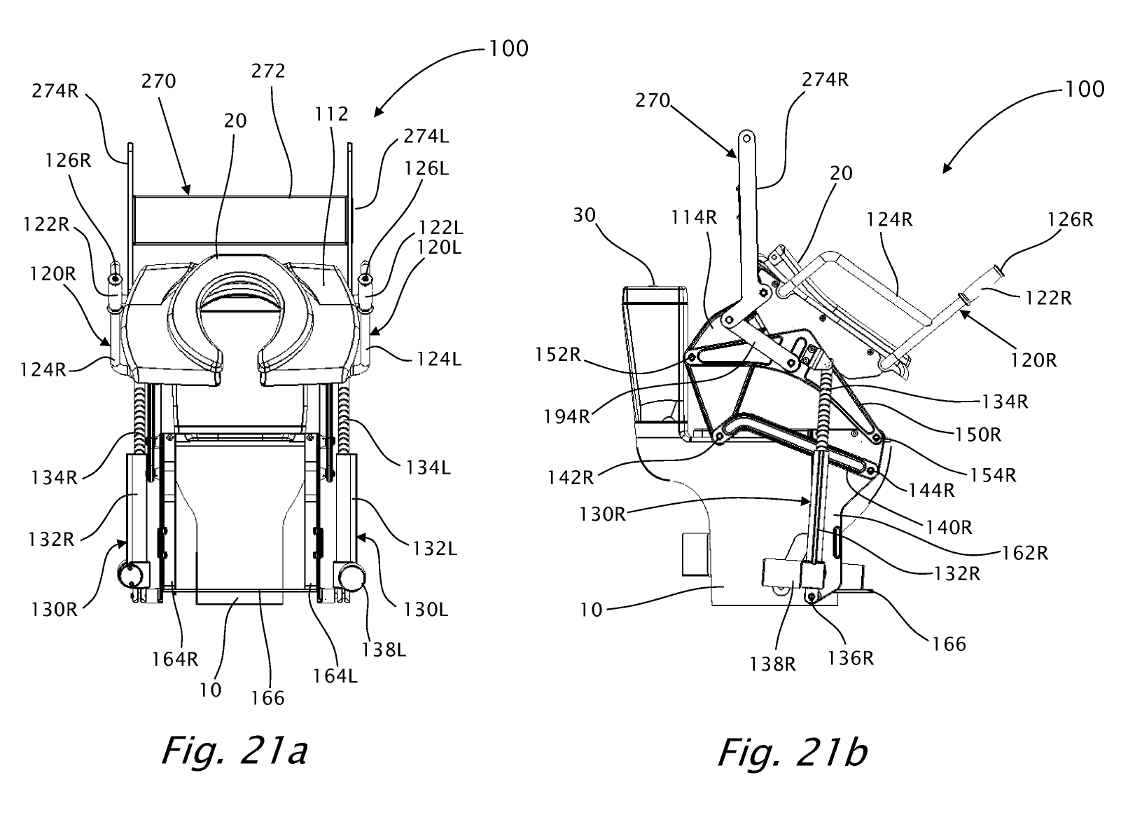

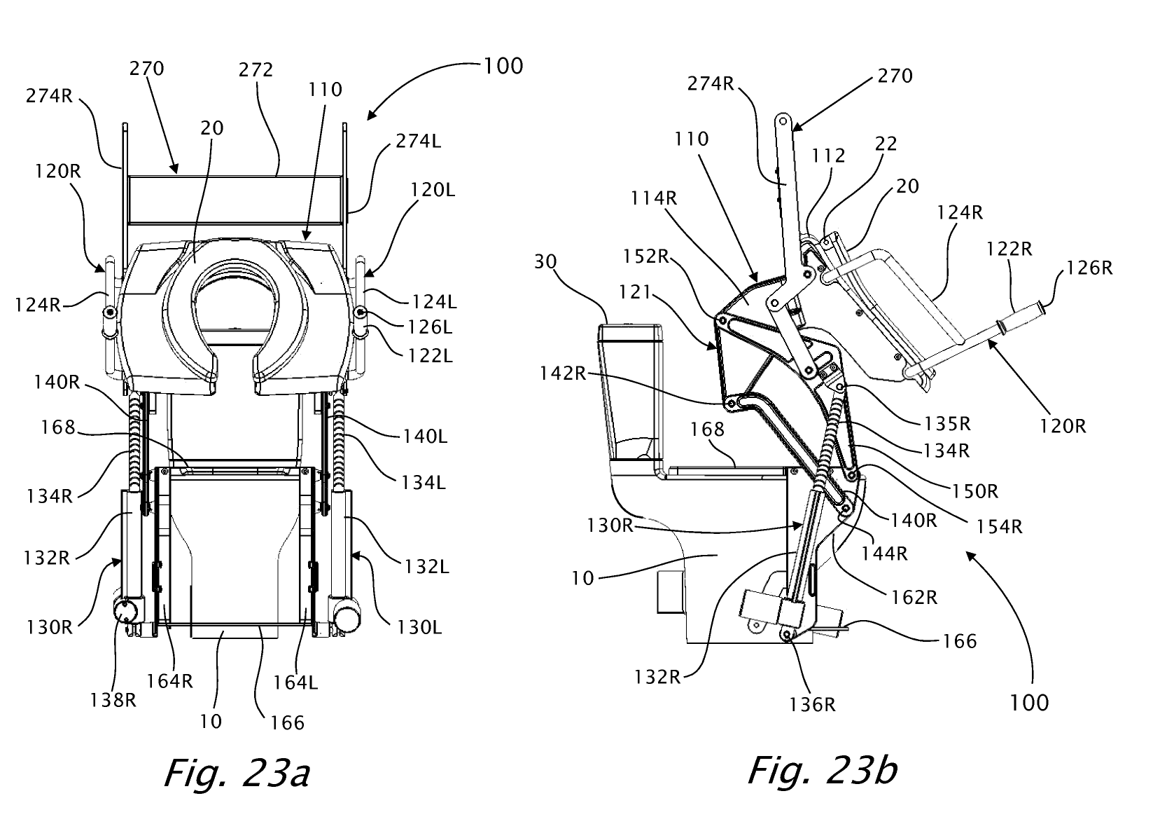

FIG. 17, illustrating an isometric view illustration of a power-assisted, ergonomic toilet seat 100 for disabled persons, according to some embodiments of the present invention, wherein ergonomic power-assisted toilet seat 100 is shown in the lower most position. FIG. 20 is an isometric view illustration of ergonomic power-assisted toilet seat 100, wherein ergonomic power-assisted toilet seat 100 is shown in an intermediate position, and in FIG. 22, ergonomic power-assisted toilet seat 100 is shown in an upper most, standing position.

Power-assisted toilet seat 100 includes a seat-support-assembly 110, a pair of arm-rest-assemblies 120, a pair of power-lifting-lowering-mechanisms 130, a stationary frame-assembly 160, and a pair of sets of radial motion creating arms 140 and 150, which conveying arms are part of a pair of side-moving-assemblies 121 that are built and operated substantially similar to side-moving-assemblies 321R and 321L of lifting-lowering-assembly 320.

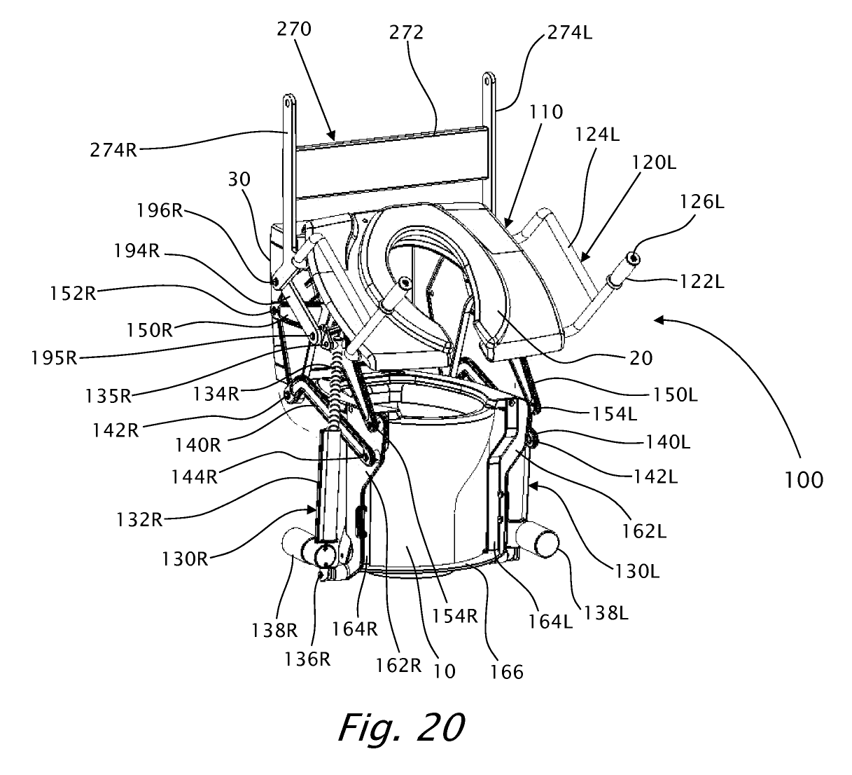

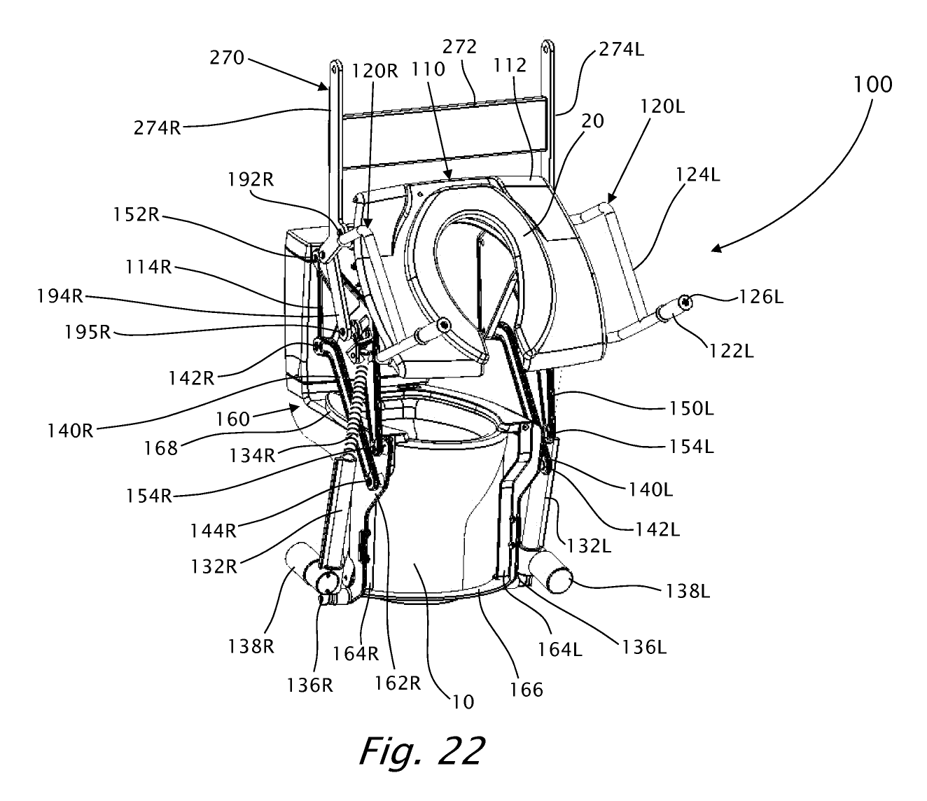

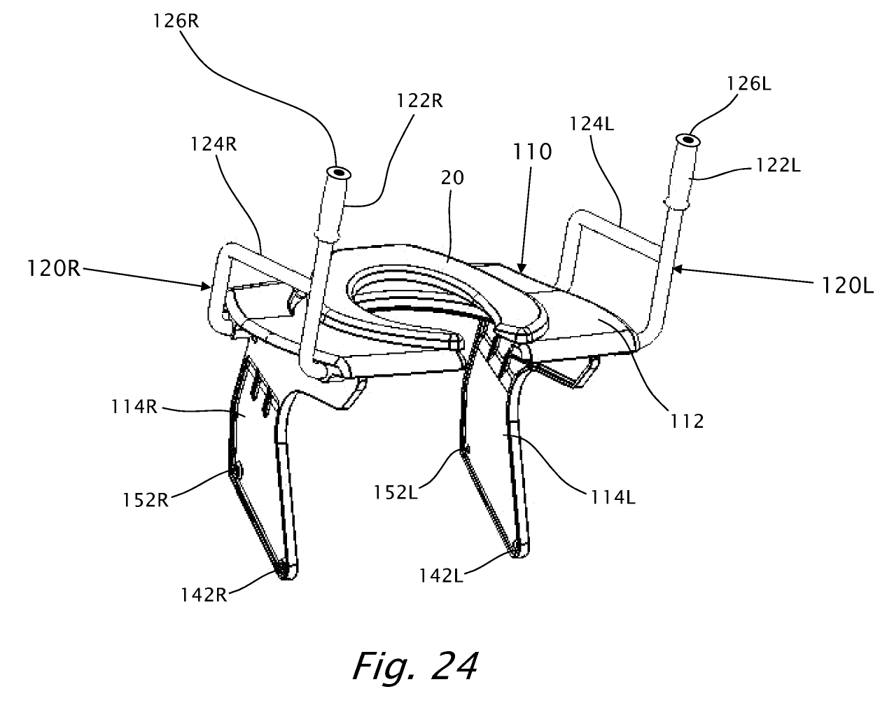

Reference is also made to FIG. 19a, a front view illustration of the power-assisted toilet seat, as shown in FIG. 17; and to FIG. 19b, a side view illustration of the power-assisted toilet seat, as shown in FIG. 17; to FIG. 21a, a front view illustration of the power-assisted toilet seat, as shown in FIG. 20; to FIG. 21b, a side view illustration of the power-assisted toilet seat, as shown in FIG. 20; to FIG. 23a, a front view illustration of the power-assisted toilet seat, as shown in FIG. 22; and to FIG. 23b, a side isometric view illustration of the power-assisted toilet seat, as shown in FIG. 22.

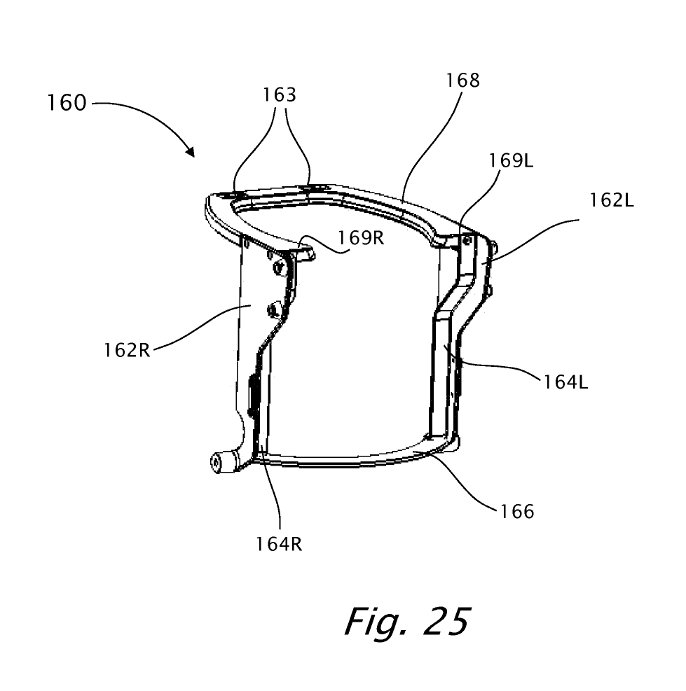

Reference is also made to FIG. 24, illustrating an isometric view illustration of seat-support-assembly 110 and the pair of arm-rest-assemblies 120. Seat-support-assembly 110 includes a seat-support-panel 112, wherein a toilet seat, typically a conventional toilet seat 20, is disposed on top of seat-support-panel 112. Typically, toilet seat 20 further includes a flashing water tank 30. Seat-support-panel 112 supports toilet seat 20 to enable the seat and an optional lid to be operatively pivoted downwardly and backwardly, when moving from an upper most position of power-assisted toilet seat 100, down to a sitting position, supported by the upper rim of toilet bowl 10. Seat-support-assembly 110 further includes a pair of vertically oriented side-walls 114, wherein seat-support-panel 112 is securely disposed onto the top edge of the respective side-walls 114R and 114L.

Arm-rest-assemblies 120R and 120L are securely attached to the upper section of surface seat-support-panel 112 on both sides of seat 20, at a convenient distance from seat 20. Each arm-rest-assembly 120 includes an arm-rest-structure 124 and a handle 122.

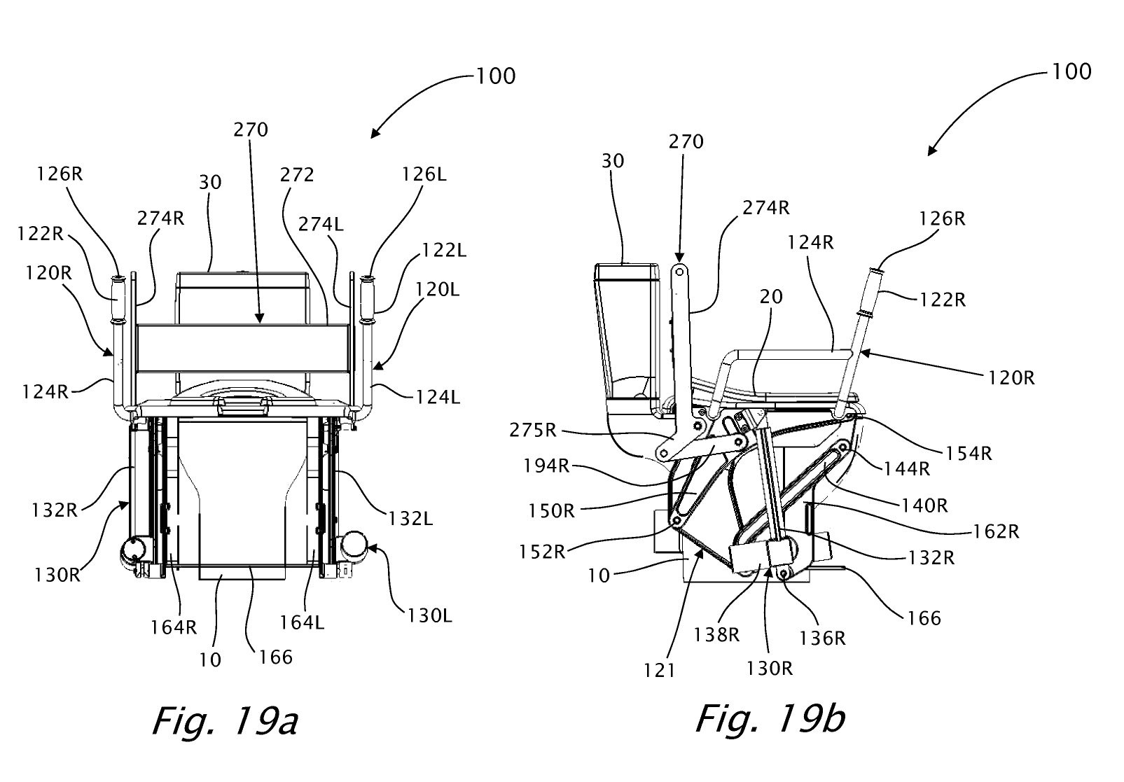

It should be noted that FIG. 18 shows an isometric view illustration of an ergonomic, power-assisted toilet seat 101, similar to ergonomic, power-assisted toilet seat 100, as shown in FIG. 17, however power-assisted toilet seat 101 further includes a feet lifting device 200. See details further in this document.

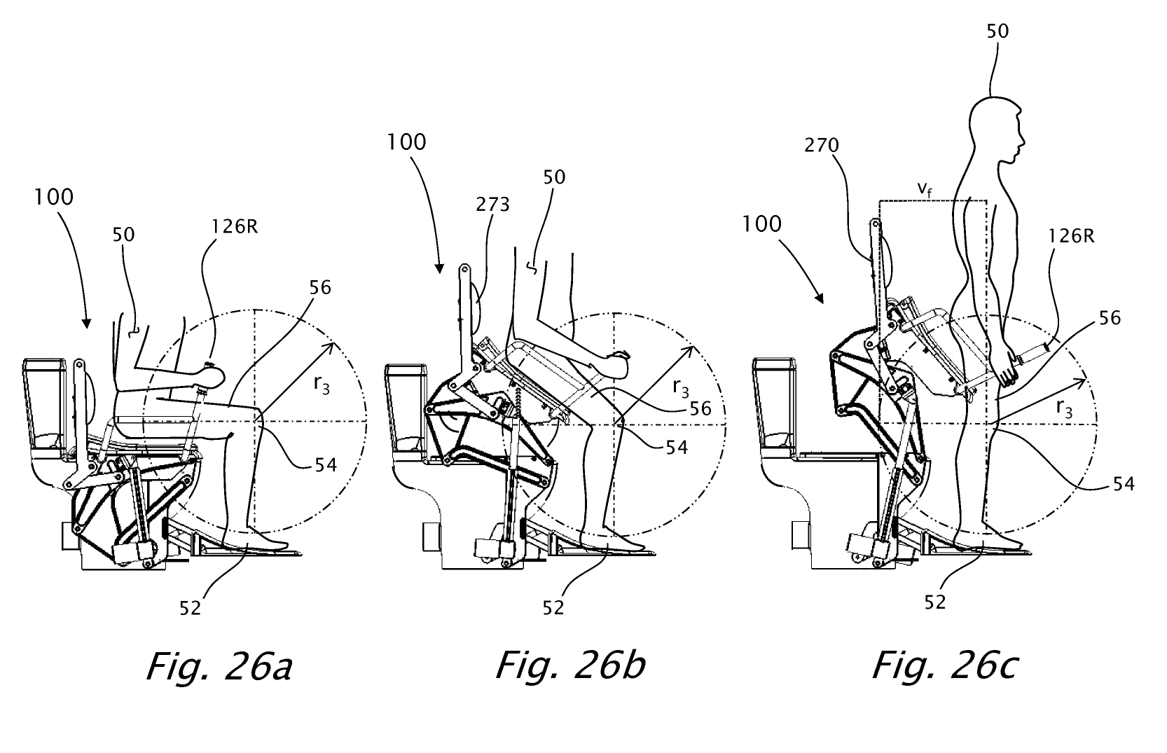

Reference is also made to FIG. 25, illustrating an isometric view illustration of frame-assembly 160. Frame-assembly 160 includes a bowl-top sub-frame 168, securely attached to the upper edge of toilet bowl 10. Bowl-top sub-frame 168 is typically U-shaped, wherein the opening is formed at the front side of the upper edge of toilet bowl 10. Typically, the rear side of bowl-top sub-frame 168 is securely attached to the upper edge of toilet bowl 10 through the common bores conventionally used to attach a conventional toilet seat 20. Frame-assembly 160 further includes vertically oriented support arms 164R and 164L each securely attached to the respective frontal ends 169 of the U-shaped bowl-top sub-frame 168, wherein vertically oriented flat-side-panels 162R and 162L are securely attached to the respective sides of support arms 164R and 164L. Frame-assembly 160 further includes a lateral and generally horizontal bottom front leg holder 166 securely interconnecting the Sidebottom ends of support arms 164R and 164L.

Power-lifting-lowering-mechanisms 130R and optional 130L include a pair of generally vertical compound jackscrews 134 that are pivotally interconnected with the respective support arms 164R and 164L, therebelow. Each power-lifting-lowering-mechanism 130 further includes an electric motor 138 powering each respective jackscrew 134 that are optionally controlled by a computerized feedback type circuitry for manually selectable or preprogrammed motion of the toilet seat structure. Each jackscrew 134 is protected by a respective housing 132 and is coupled to operate therewith. Each of the electric motor, 138R or 138L, is rotatably connected to a respective jackscrew 134. Electric motor 138 is preferably a low voltage DC or AC motor, thereby facilitating easy switching from rotating the jackscrew 134 forward to rotating the jackscrew 134 backward. It should be noted that the jackscrew mechanism is provided by way of example only, and other power lifting-lowering-mechanisms, such as pneumatic or hydraulic mechanisms, may be used.

Each pivoting mechanism of the respective side-moving-assembly uses a four-bar mechanism design to generate the radial motion, facilitating a preconfigured radial path of side-moving-assemblies 121. Each four-bar mechanism includes a lower-radial-motion-creating-arm 140 and an upper-radial-motion-creating-arm 150. Radial motion creating arms 140 and 150 are shaped and disposed such as to provide toilet seat 20 an operative motion path that closely approximates the movement of the pelvis, hips, buttocks, thighs and torso, which occurs when a person, being supported by toilet seat 20, moves between a standing position and a sitting position.

At the rear end, lower-radial-motion-creating-arm 140 is pivotally connected proximal to the lower and generally frontal (when in sitting position) end of the respective movable side-wall 114, wherein the pivoting motion is facilitated about a respective axis 142. At the front end, lower-radial-motion-creating-arm 140 is pivotally connected proximal to the upper end of the respective static flat-side-panel 162, wherein the pivoting motion is facilitated about a respective axis 144.

At a rear end, upper-radial-motion-creating-arm 150 is pivotally connected proximal to the lower and generally rear (when in sitting position) end of the respective movable side-wall 114, wherein the pivoting motion is facilitated about a respective axis 152. Thereby, the distance between pivoting axis 142 of lower-radial-motion-creating-arm 140 and pivoting axis 152 of upper-radial-motion-creating-arm 150 is fixated, while lower-radial-motion-creating-arm 140 and an upper-radial-motion-creating-arm 150 are in motion.

At the front end, upper-radial-motion-creating-arm 150 is pivotally connected proximal to the upper end of the respective static frontal arm 162, wherein the pivoting motion is facilitated about a respective axis 154 and wherein axis 154 is disposed generally above axis 144. Thereby, the distance between pivoting axis 144 of lower-arm 140 and pivoting axis 154 of upper-conveying-arm 150 is fixated, while lower-conveying-arm 340 and an upper-conveying-arm 350 are in motion.

The lower end of each housing 132 of the respective power-lifting-lowering-mechanisms 130 is pivotally connected to the respective support arm 164R or 164L, proximal to the lower end of the respective support arm 164, wherein the pivoting motion is facilitated about a respective axis 136. The upper end of the jackscrew housing 132 of each of the power-lifting-lowering-mechanisms 130 is pivotally connected to the respective upper-conveying-arm 150, proximal to the middle (proximal to the middle distance between axis 152 and axis 154) of the respective conveying arm 150, wherein the pivoting motion is facilitated about a respective axis 135.

Reference is now made to FIG. 25a, a side view illustration of power-assisted toilet seat 100, as shown in FIG. 16, illustrating the geometrical relationship to a user 50 and power-assisted toilet seat 100 of the present invention, wherein user 50 is in a seating position; to FIG. 25b, which is a side view illustration of power-assisted toilet seat 100, as shown in FIG. 19, illustrating the geometrical relationship to a user 50 and power-assisted toilet seat 100 of the present invention, but where user 50 is situated in an intermediate position between the sitting position and the standing position; and to FIG. 25c, which is a side view illustration of power-assisted toilet seat 100, as shown in FIG. 21, illustrating the geometrical relationship to a user 50 and power-assisted toilet seat 100 of the present invention, but user 50 is in a standing position.

To operate power-assisted toilet seat 100, a user 50 can, for example, press a power activator (such as a button/switch 126) disposed, for example on one or both handles 122 of a respective arm-rest-assembly 120. For example, a single switch 126 may have an OFF, UP and DOWN positions, while by using two switches 126R and 126L, one is used to operatively move seat-support-assembly 110 upwardly and the other switch is used to operatively move seat-support-assembly 110 downwardly. For description convenience only, with no limitation, the operation of power-assisted toilet seat 100 will be described in terms of using a single switch 126.

To move power-assisted toilet seat 100 from a sitting position to a standing position, user 50 activates switch 126 to lift (UP switch position) seat-support-assembly 110 upwardly. Thereby, motors 138R and 138L are activated to rotate the respective jackscrew 134, for example forward, to operatively lift seat-support-assembly 110 upwardly. Preferably, as long as user 50 activates switch 126, seat-support-assembly 110 keeps moving upwardly, until reaching the end position, where seat-support-assembly 110 reaches a near standing position and electric motors 138R and 138L are deactivated.

While seat-support-assembly 110 is being lifted, each jackscrew 134 moves slowly upwardly, thereby pushing upper-radial-motion-creating-arm 150 upwardly. Each upper-radial-motion-creating-arm 150, being rotatably attached to the lower and generally rear end of a respective movable side-wall 114, pivotally pushes seat-support-assembly 110 upwardly, while lower-radial-motion-creating-arm 140 keeps seat 20 in an inclination angle that approximates the inclination angle of the rear side of the thighs of user 50, as user 50 moves from sitting position to standing position. Hence, each respective movable side-wall 114 serves as a motion-conveying-member, being part of a four-bar mechanism design. The motion-conveying-member conveys a radial motion, created by upper-radial-motion-creating-arm 150 and lower-radial-motion-creating-arm 140, to seat-support-assembly 110.

As seat-support-assembly 110 moves upwardly, the feet 52 of user 50 remain steady on the floor (or any other hard surface). The center of rotation of seat-support-assembly 110 is approximated to be at knees 54 of user 50. The operative motion path of toilet seat 20 is designed to closely approximate the pivotal motion of the thighs 56, pivoting about the knees 54, as toilet seat 20 moves from a sitting position to a standing position while supporting the buttocks of user 50.

Similarly, to move power-assisted ergonomic toilet seat 100 from a standing position to a sitting position, user 50 activates switch 126 to lower (DOWN switch position) seat-support-assembly 110 downwardly. Thereby, motors 138R and 138L are activated to rotate jackscrew 134, for example backward, to facilitate the lowering of seat-support-assembly 110 downwardly. The geometry and the physics of the lowering power-assisted ergonomic lifting/lowering apparatus 300 from a standing position to a sitting position, is the reverse motion of the lifting operation described here above. It should be noted that when moving power-assisted ergonomic toilet seat 100 from a standing position to a sitting position, as jackscrew 134 rotate backwards the seat may move down by the weight of the seating person 50 and/or the gravity force applied to power-assisted ergonomic toilet seat 100. Hence, each respective movable side-wall 114 serves as a motion-conveying-member, being part of a four-bar mechanism design. The motion-conveying-member conveys a radial motion, created by upper-radial-motion-creating-arm 150 and lower-radial-motion-creating-arm 140, to seat-support-assembly 110.

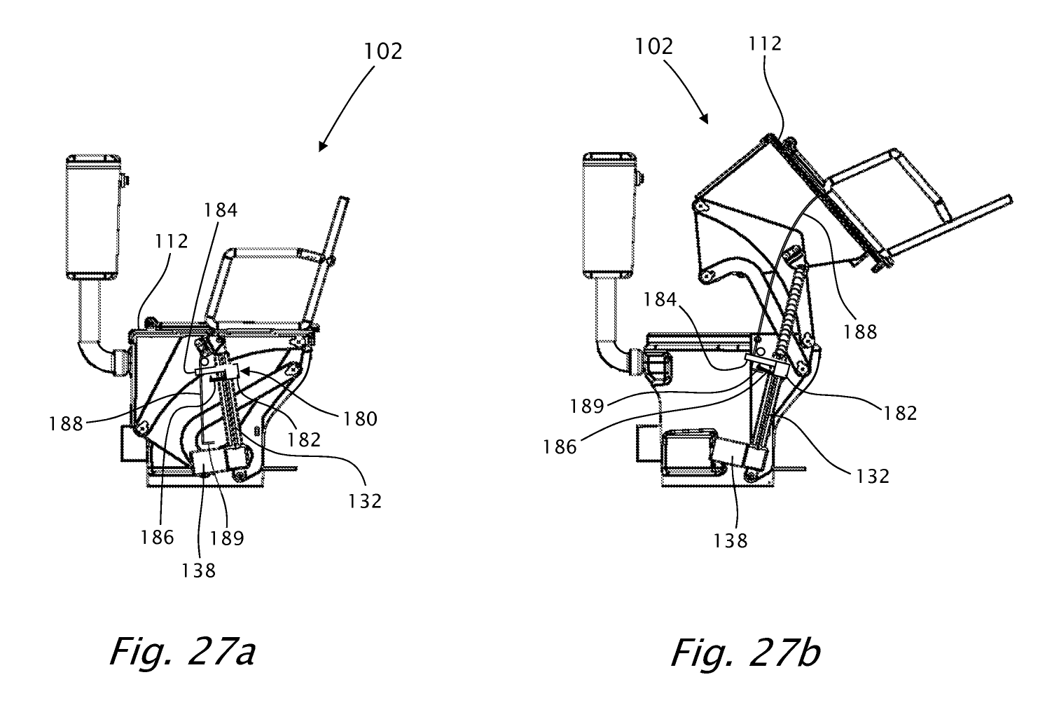

Reference is now made to FIGS. 3a-3c, side view illustrations of power-assisted ergonomic lifting/lowering apparatus 300, illustrating the geometrical relationship to a user 50 and power-assisted ergonomic lifting/lowering apparatus 300 of the present invention. In FIG. 26a, user 50 is shown in a sitting position, whereas power-assisted, ergonomic toilet seat 100 is in the lower most position. In FIG. 26c, user 50 is shown in a standing position, whereas power-assisted, ergonomic toilet seat 100 is in the upper most position and wherein the physical effort required from user 50 to reach the standing position is minimalistic. In FIG. 26b, user 50 is shown in an intermediate state, in which state user 50 is moving between the sitting position and the standing position.

To operate power-assisted, ergonomic toilet seat 100, a user 50 (or another person) can use a wired control unit, a wireless control unit or any other electric switching operation known in the art. In the example shown in the figures, to move power-assisted toilet seat 100 from the sitting position to the standing position, user 50 activates switch 126 to lift (UP switch position) seat-support-assembly 110 upwardly. Thereby, electric motors 138R and 138L are activated to rotate jackscrew 134, for example forward, to operatively lift seat-support-assembly 110 upwardly and forward. Preferably, as long as user 50 activates switch 126, seat-support-assembly 110 keeps moving upwardly, until reaching the end position, where seat-support-assembly 110 reaches a near standing position and electric motors 138R and 138L are deactivated. While seat-support-assembly 110 is being lifted, each jackscrew 134 moves slowly upwardly, thereby pushing upper-radial-motion-creating-arm 150 upwardly. Each upper-radial-motion-creating-arm 150, being rotatably attached to the lower and generally rear end of a respective movable side-wall 114, pivotally pushes seat-support-assembly 110 upwardly and forward, in a preconfigured radial path (similar to the operate power-assisted ergonomic lifting/lowering apparatus 300), while lower-radial-motion-creating-arm 140 keeps seat 20 in an inclination angle that approximates the inclination angle of the rear side of the thighs of user 50, as user 50 moves from sitting position to standing position. Thighs 56 of user 50 moved from horizontal posture to upright posture, wherein torso 57 of user 50 moved forward by a designated forward lateral distance v_{f}.

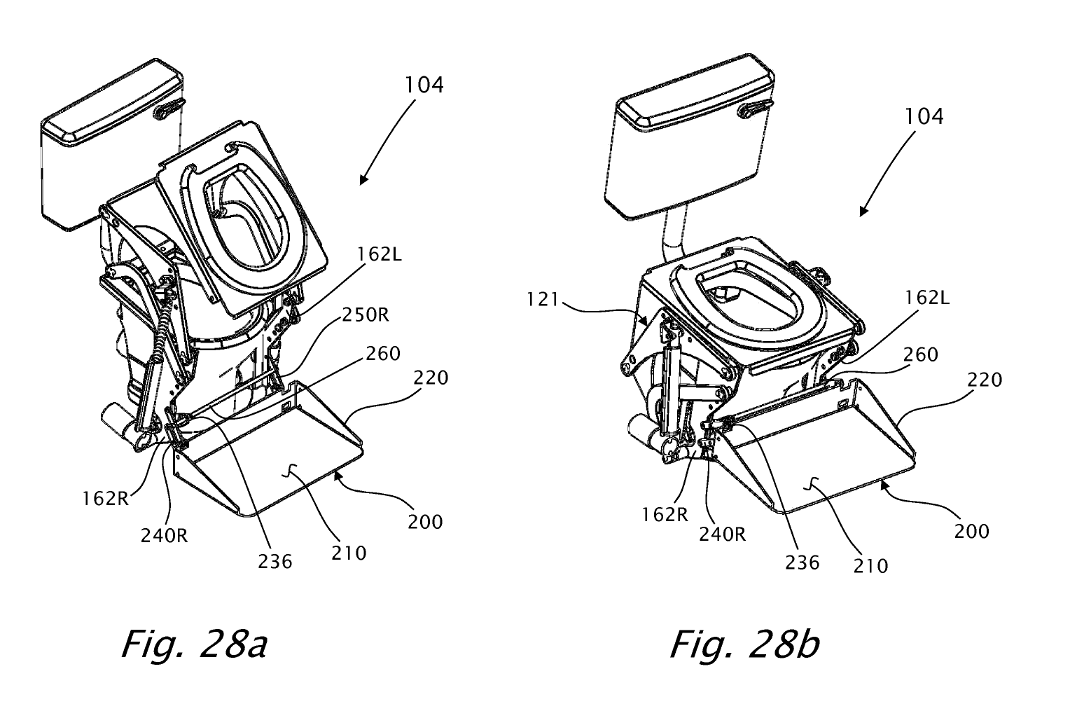

According to some embodiments of the present invention, the power-assisted toilet seat 100 includes a height adjustment mechanism, similar to height adjustment mechanism of power-assisted ergonomic lifting/lowering apparatus 300. Reference is made to FIGS. 27a and 27b, which are side view illustrations of a power-assisted toilet seat 102, as shown in FIG. 17 and FIG. 22, respectively, but also having a height-adjusting-mechanism 180. Height-adjusting-mechanism 180 includes an electric limit switch facilitated to operatively turn ON/OFF the activation power to electric motors 138. In the example shown in the figures, height-adjusting-mechanism 180 is preset such that when power-assisted toilet seat 102 is moving from sitting position to standing position, a height-adjusting-mechanism 180 deactivates the power to electric motors 138 at a predesigned spatial location, thereby stopping seat-support-assembly 110 at the predesigned height, which height is typically fitted to the height of a user 50. As a consequence, the forward lateral distance v_{f} of the toilet lifting assembly of power-assisted toilet seat 100 can be adjusted to serve a particular user 50.

The electric limit switch described herein, is described by way of example only, and can be implemented in many variations, known in the art. In the examples shown in FIGS. 27a and 27b, height-adjusting-mechanism 180 includes a body 182 securely attached, for example to housing 132 of power-lifting-lowering-mechanisms 130. Height-adjusting-mechanism 180 further includes rigid arm 184 extending from body 182 and a flexibly contact arm 186, wherein when flexibly contact arm 186 is pushed towards rigid arm 184 and a contact is made between flexibly contact arm 186 contact arm 186 an electric circuit is closed, thereby operatively deactivating electric motors 138. It should be noted that in variations of the present invention flexibly contact arm 186 is pushed away from rigid arm 184 and thereby an electric circuit is opened to thereby operatively deactivate electric motors 138.

The example mechanism for pushing flexibly contact arm 186 towards or away from rigid arm 184 includes a semi rigid wire 188 securely attached at a first end to seat-support-assembly 110, generally above adjusting mechanism 180. Proximal to the second end of semi rigid wire 188, a rigid element 189 is securely attached to semi rigid wire 188, extending generally perpendicular to semi rigid wire 188. As seat-support-assembly 110 moves operatively upwardly, semi rigid wire 188 moves upwardly too, proximal to flexibly contact arm 186 but without actively touching flexibly contact arm 186. At a certain predesigned length of semi rigid wire 188, rigid element 189 reaches flexibly contact arm 186, and pushes flexibly contact arm 186 immediately thereafter, to thereby operatively deactivate electric motors 138.

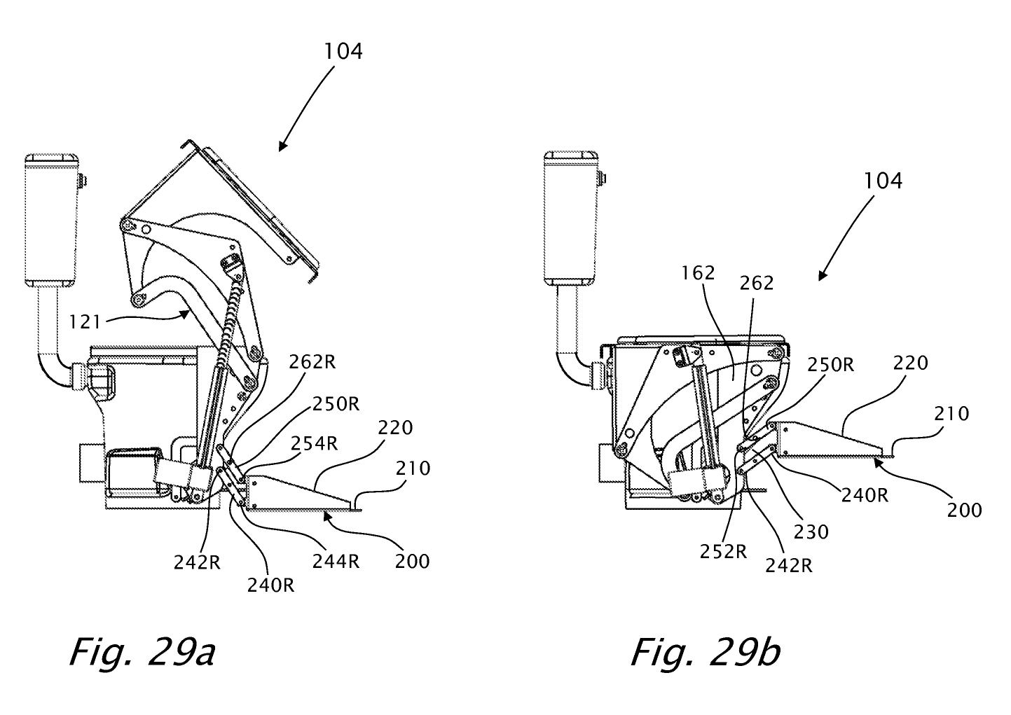

In variations of the present invention, the power-assisted toilet seat includes a device for moving the legs and knees of a sitting person 50 upwardly, thereby bringing person 50 proximal to a squat position. Reference is made to FIGS. 28a and 28b, which are isometric view illustrations of a power-assisted toilet seat 104, as shown in FIG. 17 and FIG. 22, respectively, but also having a feet-lifting-lowering-device 200, according to variations of the present invention. Feet lifting device 200 includes a lifting tray 220, having a standing plate support 210.

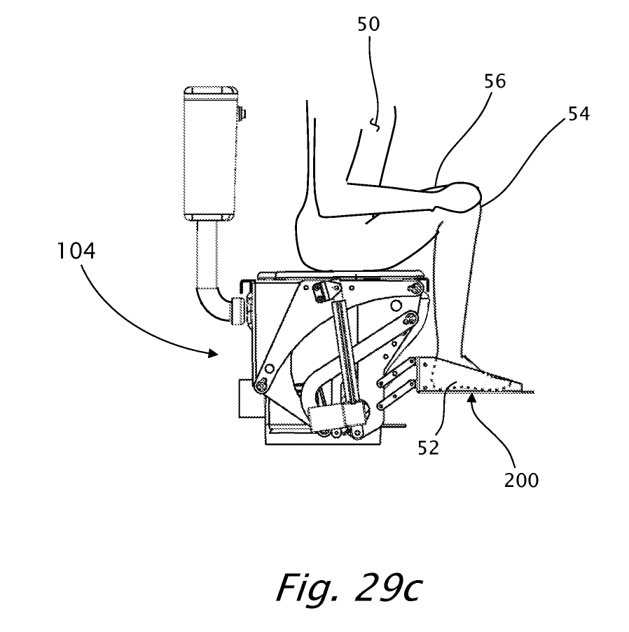

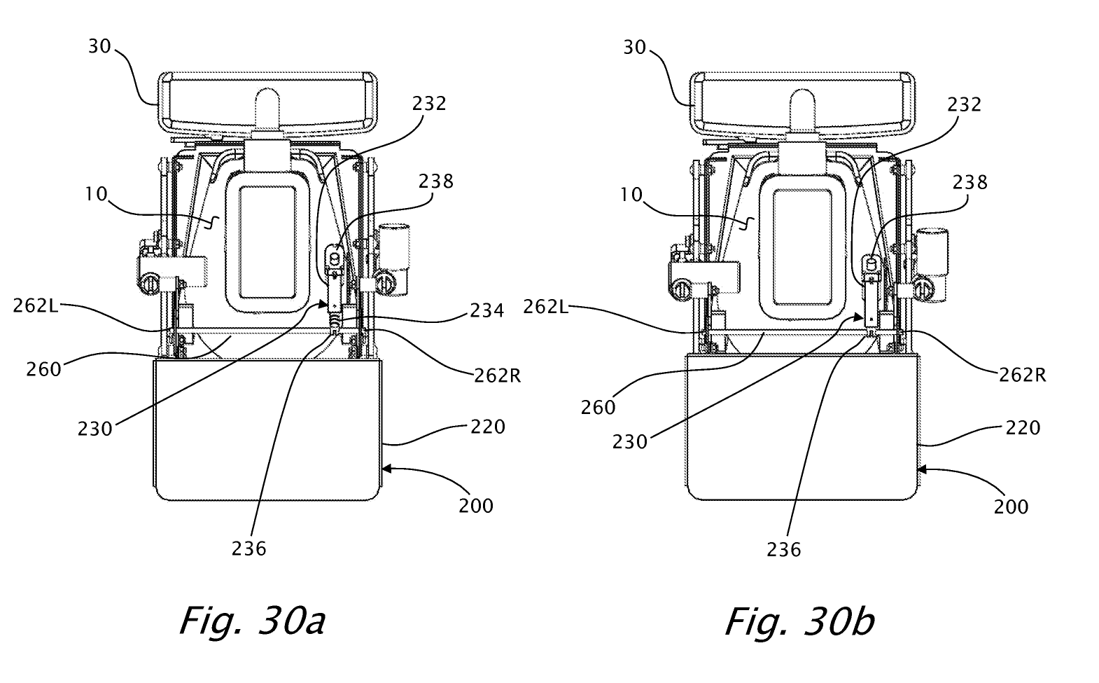

Reference is also made to FIG. 29a, which is a side view illustration of power-assisted toilet seat 104, as shown in FIG. 20a, wherein feet lifting device 200, for moving the legs and knees of a sitting person upwardly, is in a down position; to FIG. 29b, which is a side view illustration of power-assisted toilet seat 104, as shown in FIG. 28b, wherein feet lifting device 200, for moving the legs and knees of a sitting person upwardly, is in an upper position; to FIG. 29b, which is a side view illustration of power-assisted toilet seat 104, as shown in FIG. 28b, wherein feet lifting device 200, for moving the legs and knees of a sitting person upwardly, is in an upper position and thereby bringing person 50 proximal to a squat position; to FIG. 30a, which is a bottom view illustration of power-assisted toilet seat 104, as shown in FIG. 28a; and to FIG. 30b, which is a bottom view illustration of power-assisted toilet seat 104, as shown in FIG. 28b.

The feet-lifting-lowering-mechanism, for moving the legs and knees of a person 50 sitting of on toilet seat 20 of power-assisted toilet seat 104, upwardly, will now be described by way of example only, and can be implemented in many variations, known in the art.

In the examples shown in FIGS. 28a-30b, feet lifting device 200 further includes one or two motors 238, a pair of sets of motion conveying arms 240 and 250, and a motion conveying bar 260. When a user 50 wants to use power-assisted toilet seat 104, lifting tray 220 is in a down position (see FIG. 28a), typically supported by the floor below.

While user 50 is sitting on toilet seat 20 in a normal manner, user 50 may lift lifting tray 220 to thereby move the feet and knees of a sitting person upwardly, thereby bringing person 50 proximal to a squat position, thereby assisting a person 50 suffering, for example, from constipation (see FIG. 29c).

Feet-power-lifting-lowering-mechanism 230 includes a compound jackscrew that is securely attached to frame-assembly 160 of power-assisted toilet seat 104. Electric motor 238 powers jackscrew 234 that is optionally controlled by a computerized feedback type circuitry for manually selectable or preprogrammed motion of the toilet seat structure. The electric motor 238 is rotatably connected to jackscrew 234. Jackscrew 234 is protected by a housing 232 of feet-power-lifting-lowering-mechanisms 230. Typically, an electric motor, 238 is a DC motor, thereby facilitating easy switch from rotating jackscrew 234 forward to rotating backward. It should be noted that the jackscrew mechanism is provided by way of example only, and other power lifting/lowering mechanisms, such as pneumatic or hydraulic mechanisms, may be used.

Each set of motion conveying arms includes a lower-conveying-arm 240 and an upper-conveying-arm 250 disposed substantially parallel to each other. At a first end, lower-conveying-arm 240 is pivotally connected to static frontal arm 162 at a predetermined location, wherein the pivoting motion is facilitated about a respective axis 242. At the second end, lower-conveying-arm 240 is pivotally connected proximal to the lower end of the back side of lifting tray 220, wherein the pivoting motion is facilitated about a respective axis 254. At a first end, upper-conveying-arm 250 is pivotally connected to static frontal arm 162 at a predetermined location, wherein the pivoting motion is facilitated about a respective axis 252. At the second end, lower-conveying-arm 250 is pivotally connected proximal to the upper end of the back side of lifting tray 220, wherein the pivoting motion is facilitated about a respective axis 254.

Motion conveying bar 260 is pivotally disposed, in a lateral orientation, between a predesigned pair either lower-conveying-arms 240R and 240L or upper-conveying-arms 250R and 250L. In the example shown in FIGS. 28a-30b, motion conveying bar 260 is pivotally disposed between upper-conveying-arms 250R and 250L, wherein the pivoting motion is facilitated about respective axes 262R and 262L.

The upper end of jackscrew housing 232 of feet-power-lifting-lowering-mechanism 230 is securely connected to motion conveying bar 260, at a predesigned angel. Thereby, when jackscrew 234 pivotally pushes motion conveying bar 260, in a forward and upward direction, motion conveying bar 260 pivots about axes 262.

To move lifting tray 220 upwardly, user 50 activates motor 230, for example by activating an electric switch (not shown). Thereby, electric motor 238R is activated to rotate jackscrew 234, for example forward, to operatively lift lifting tray 220 upwardly. Preferably, as long as user 50 activates the switch, lifting tray 220 keeps moving upwardly, until reaching the upper position, when electric motor 238 is deactivated. While lifting tray 220 is being lifted, jackscrew 234 moves slowly forwardly and upwardly, thereby pushing upper-conveying-arm 250 upwardly. Each upper-conveying-arm 250, being rotatably attached to static frontal arm 162, pivotally pushes lifting tray 220 upwardly, while lower-conveying-arms keep standing plate support 210 generally horizontal, as the feet and knees of user 50 move upwardly, thereby bringing him/her proximal to a squat position.

The geometry and the physics of the lowering lifting tray 220 from the upper position to the lower position, is the reverse motion of the lifting operation described hereabove.

Preferably, the ergonomic, power-assisted toilet seat (100, 101, 102 and 104) further includes a back-support-assembly 270. Back-support-assembly 270 may include a back-support-plate 272 that may be cushioned by a cushion 273 (see FIG. 26b) and a pair of motion-relay-support-arms 274, securely attached onto the sides of back-support-plate 272. For safety and good support, in particular but with no limitations, in a squatting position, there is a need to keep back-support-plate 272 in a substantially upright position, throughout the motion path of the ergonomic, power-assisted toilet seat (100, 101, 102 and 104). The mechanism used to keep back-support-plate 272 in a substantially upright position is similar to the mechanism used to maintain motion-relay-units 324 in the same spatial orientation throughout the motion path of side-moving-assemblies 321.

Motion-relay-support-arms 274, being securely attached to back-support-plate 272, are also substantially vertical. The upper end of motion-relay-support-arm 274 is an open end. From the lower end of motion-relay-support-arm 274, another bar 275 is extending sideways at a preconfigured angle, wherein bores 192 and 196 are formed proximal to the two ends of bar 275, and wherein bores 192 and 196 are formed at a preconfigured location and with a preconfigured distance between them. Bores 192 and 196 are designed to accommodate pivotal axes, having a similar function as axes 392 and 396, respectively.

To substantially maintain back-support-plate 272 in a substantially upright position, an orientation-maintaining-arm 194, substantially similar to orientation-maintaining-arm 394, is introduced. At a first end, orientation-maintaining-arm 194 is securely attached to upper-conveying-arm 150 at a preconfigured location 195 (see FIGS. 20 and 22), proximal to the middle of upper-conveying-arm 150. At the other end, orientation-maintaining-arm 194 is pivotally attached to bar 275 at the first end, wherein the pivoting motion is facilitated about the axis of bore 196 (see FIG. 18). Furthermore, the other end of bar 275 is also pivotally attached to the respective side-wall 114, at a preconfigured location, wherein the pivoting motion is facilitated about the axis of bore 192 (see, for example, FIGS. 17 and 18).

It should be noted that side-walls 114 of power-assisted toilet seats 100, 101, 102 and 104 prevent a “scissors” which may, in some prior art power-assisted toilet seats cut or damage fingers of a user of the power-assisted toilet seat, or any other elongated items caught between moving arms.

It should be noted that the weight of users of power-assisted toilet seats 100, 101, 102 and 104 is limited only by the power of electric motors 138.

It should be noted that the shapes of all parts of all elements of power-assisted toilet seats 100, 101, 102 and 104 may vary, but remain within the scope of the present invention.

In variations of the present invention, power-assisted toilet seats 100, 101, 102 and 104 includes toilet seat accessories such as a bidet, seat heater etc.

In variations of the present invention, a lifting-lowering-assembly, such as lifting-lowering-assembly 320, as used for power-assisted ergonomic lifting/lowering apparatus 300 (or power-assisted toilet seat 100) is use for moving a person between sitting and standing positions in chairs, armchairs, recliners, sofas, etc.

In variations of the present invention, one or more of the electric limit switches of power-assisted toilet seats 100, 101, 102 and 104 are magnetic activated limit switches.

It should be noted that power-assisted toilet seats 100, 101, 102 and 104 can be mounted on any toilet replacing the toilet seat and using the mounting holes of the toilet seat.

In variations of the present invention, power-assisted toilet seats 100, 101, 102 and 104 are made of modular components, to thereby provide a do-it-yourself power-assisted toilet seat kit.

The invention being thus described in terms of embodiments and examples, it will be obvious that the same may be varied in many ways. Such variations are not to be regarded as a departure from the spirit and scope of the invention, and all such modifications as would be obvious to one skilled in the art are intended to be included within the scope of the claims.

What is claimed is:

1. An ergonomic lifting-lowering unit for lifting and/or lowering a user, such as a disabled person, the power-assisted lifting-lowering unit comprising:
a) a body-holder adapted to firmly hold or support the torso of the user at least at one body member and/or body section of the torso;
b) a lifting-lowering-mechanism comprising:
i) at least one power actuator, wherein said power actuator is operatively engaged with said body-holder, at preconfigured locations; and
ii) a power providing member for operating said power actuator;
c) a motion and force transmitting mechanism; and
d) a power activator,
wherein said power activator is in operational communication with said power actuator to thereby set in motion said motion transmitting mechanism that causes said body-holder to move in a path closely approximating to the movement of the femur bones, or a in path parallel thereto, when the user is moving between a standing position and a sitting position, the knees being the proximal center of the pivotal motion of the femur bones of the user.

2. An ergonomic lifting-lowering unit, as in claim 1, further comprises:
e) a height adjustment mechanism, adapted to adjust said path of motion that closely approximates the movement of the femur bones, to thereby adapt to the actual bodily dimensions of the user, including the height of the popliteal of the user.

3. An ergonomic lifting-lowering unit as in claim 1, wherein substantially all the lifting force that is required to lift a user from a sitting position to a standing position is provided by said lifting-mechanism and no physical effort is required from the user.

4. An ergonomic lifting-lowering unit as in claim 1, wherein said body-holder comprises seat-support-assembly, adapted to support the buttocks of the user, when the user is moving between a standing position and a sitting position.

5. An ergonomic lifting-lowering unit as in claim 1, wherein said body-holder comprises a user-support-assembly having a pair of armpit-rest-units, adapted to support the armpits of the user, when the user is moving between a standing position and a sitting position.

6. An ergonomic lifting-lowering unit as in claim 5, wherein said user-support-assembly further comprises a harness firmly accommodating selected sections of the torso of the user.

7. An ergonomic lifting-lowering unit as in claim 1, wherein said at least one power actuator is an elongated device having two ends, and wherein a first end is pivotally attached to a stationary frame, at a preconfigured location, and wherein the second end is pivotally attached to a member of said motion transmitting mechanism, at a preconfigured location.

8. An ergonomic lifting-lowering unit as in claim 1, wherein said at least one power actuator is a compound jackscrew, and wherein said power providing member is a motor that is rotatably connected to said compound jackscrew.

9. An ergonomic lifting-lowering unit as in claim 1, wherein said power providing member is selected from a group of power lifting-lowering-mechanisms including a pneumatic mechanism and a hydraulic mechanism.

10. An ergonomic lifting-lowering unit as in claim 1, wherein said power actuator is selected from a group of power actuator including a pneumatic cylinder and a hydraulic cylinder.

11. An ergonomic lifting-lowering unit as in claim 1, wherein said motion transmitting mechanism comprises at least one pair of radial-motion-creating-arms, wherein each said pair of radial-motion-creating-arms comprises:
a) a lower-radial-motion-creating-arm;
b) an upper-radial-motion-creating-arm; and
c) a motion-conveying-member,
wherein a rear end of said lower-radial-motion-creating-arms is pivotally attached to lower section of said motion-conveying-member, at a preconfigured location; and wherein a front end of said lower-radial-motion-creating-arm is pivotally attached to the top section of a stationary frame, at a preconfigured location;
wherein a rear end of said upper-radial-motion-creating-arm is pivotally attached to a higher section of said motion-conveying-member, at a preconfigured location; and wherein a front end of said upper-radial-motion-creating-arm is pivotally attached to said stationary frame, at a preconfigured location disposed generally above said front end of said lower-radial-motion-creating-arm;
wherein said power activator is pivotally attached to said upper-radial-motion-creating-arm, at a preconfigured location; and
wherein when said power activator is activated, said motion-conveying-member moves in a path closely approximating to the movement of the femur bones, or in a path parallel thereto.

12. An ergonomic power-assisted lifting-lowering apparatus comprising a lifting-lowering-assembly comprising a pair of side-moving-assemblies (321), each having said power-assisted lifting-lowering unit as in claim 7,
wherein said body-holder comprises a pair of user-support-assemblies wherein body-holder is adapted to firmly support the armpits of the user;
wherein said stationary frame is a stationary frame-assembly (360) that comprises:
a) a pair of vertically oriented side-frame-structures, each having an inner face and an external face, a front side and a rear side; and
b) a vertically oriented front-frame-structure,
wherein said frontal inner sides of said side-frame-structures are securely interconnected by said front-frame-structure, leaving an opened space at the rear of said stationary frame-assembly, to thereby facilitate accommodating the user between said side-frame-structures; and
wherein said lifting-lowering-assembly further comprises a front-moving-structure,
wherein said side-moving-assemblies are securely interconnected by said front-moving-structure, leaving an opened space at the rear of said lifting-lowering-assembly, to thereby facilitate accommodating the user between said side-moving-assemblies;
wherein each said power-assisted lifting-lowering units further comprises:
a) a motion-relay-unit; and
b) an orientation-maintaining-arm (394),
wherein each said user-support-assemblies includes an adjustable armpit-rest-unit;
wherein each said user-support-assemblies is attached to respective said motion-relay-unit; and
wherein a first end of said orientation-maintaining-arm is securely attached to said upper-radial-motion-creating-arm at a preconfigured location and the second end of said orientation-maintaining-arm is pivotally attached to said motion-relay-unit, at a preconfigured location, to thereby maintain said motion-relay-unit in a substantially constant spatial orientation, including when the user is moving between a standing position and a sitting position, such that respective said armpit-rest-unit is maintained in a substantially upright orientation.

13. An ergonomic power-assisted lifting-lowering apparatus as in claim 12, wherein each said armpit-rest-unit further comprises:
a) a hollow sleeve-unit, adapted to fittingly accommodate a sliding-arm; and
b) a locking device,
wherein said locking device is preconfigured to allow free upward movement of said sliding-arm inside said sleeve-unit, wherein when said locking device is in a locked state, said locking device is preconfigured to prevent downward movement of said sliding-arm inside said sleeve-unit.

14. An ergonomic power-assisted lifting-lowering apparatus as in claim 13, wherein said user-support-assembly further comprises:
a) a horizontal-arm, extending sideways from the top end of said sliding-arm, wherein said horizontal-arm is securely attached thereto; and
b) a hollow top-arm, extending upwardly from the other end of said horizontal-arm, wherein said top-arm is securely attached thereto,
wherein said armpit-rest-unit is rotatably accommodated inside said top-arm and thereby, facilitating said armpit-rest-unit to comfortably adapt to the armpit of user.

15. An ergonomic power-assisted lifting-lowering apparatus as in claim 13, wherein said body-holder further comprises a harness firmly accommodating selected sections of the torso of the user.

16. An ergonomic power-assisted toilet seat, comprising a lifting-lowering-assembly comprising a pair of side-moving-assemblies (121), each having said power-assisted lifting-lowering unit as in claim 11,
wherein said body-holder is a seat-support-assembly adapted to firmly support the buttocks and thighs of the user;
wherein said stationary frame is a stationary frame-assembly (160), facilitated to securely attach to the top of a toilet seat bowl through the common bores conventionally used to attach a conventional toilet seat, said frame-assembly comprising:
a) interconnected stationary frame members adapted to embrace the toilet seat bowl;
b) a U-shaped bowl-top sub-frame disposed substantially parallel to the top rim of the toilet seat bowl, wherein the two arms of said U-shaped bowl-top sub-frame are pointing towards the front of the toilet seat bowl; and
c) a leg holder disposed at the front of the toilet seat bowl proximal and substantially parallel to the floor,
wherein said lifting-lowering-assembly further comprises:
a) a U-shaped seat-support-panel, wherein the two arms of said U-shaped seat-support-panel are pointing towards the front of the toilet seat bowl; and
b) side-walls, being said motion-conveying-member;
wherein said U-shaped seat-support-panel is adapted to securely carry a conventional toilet seat; and
wherein when said power activator is activated, said motion-conveying-member moves in a path closely approximating to the movement of the femur bones, or in a path parallel thereto.

17. An ergonomic power-assisted toilet seat as in claim 16, wherein each said power-assisted lifting-lowering units further comprise:
a) a back-support-plate;
b) motion-relay-support-arms; and
c) an orientation-maintaining-arm (194),
wherein said back-support-plate securely interconnects said motion-relay-support-arms; and
wherein a first end of said orientation-maintaining-arm is securely attached to said upper-radial-motion-creating-arm at a preconfigured location, and the second end of said orientation-maintaining-arm is pivotally attached to respective said motion-relay-support-arms, at a preconfigured location, to thereby maintain said back-support-plate in a substantially constant spatial orientation, including when the user is moving between a standing position and a sitting position, such that said back-support-plate is maintained in a substantially upright orientation.

18. An ergonomic power-assisted toilet seat as in claim 16 further comprises at least one arm-rest-assembly.

19. An ergonomic power-assisted toilet seat as in claim 18, wherein said power activator is disposed at preconfigured location on each of said arm-rest-assemblies.

20. An ergonomic power-assisted toilet seat as in claim 19, wherein when said U-shaped seat-support-panel moves between said standing position and said sitting position, said preconfigured location of said power activator remains conveniently accessible to the user.

21. A power-assisted toilet seat as in claim 16, wherein said at least one power actuator is a compound jackscrew, wherein said power providing member is a motor that is rotatably connected to said compound jackscrew wherein rotating said motor in a first direction, lifts said U-shaped seat-support-panel from said sitting position to said standing position, and wherein rotating said motor in a second direction, lowers said U-shaped seat-support-panel from said standing position to said sitting position.

22. An ergonomic power-assisted toilet seat as in claim 16 further comprises a height adjustment mechanism, adapted to adjust said path of motion that closely approximates the movement of the femur bones, to thereby adapt to the actual bodily dimensions of the user, including the height of the popliteal of the user.

23. An ergonomic power-assisted toilet seat as in claim 16 further comprises a feet-lifting-device for moving the legs and knees of a sitting person upwardly, the device comprising:
a) a lifting-tray;
b) a tray-lifting mechanism; and
c) a second power activator,
wherein said tray-lifting mechanism is in operational communication with said lifting-tray; and
wherein said second power activator is in operational communication with said tray-lifting mechanism.

24. An ergonomic power-assisted toilet seat as in claim 23, wherein said tray-lifting mechanism comprises:
a) a motion conveying bar;
b) a second power actuator; and
c) a motor,
wherein activating said second power activator activates said motor to rotatably activate said second-power actuator to thereby move said lifting-tray in a generally vertical direction.

25. An ergonomic power-assisted toilet seat as in claim 24, wherein rotating said motor in a first direction, lifts said U-shaped seat-support-panel from said sitting position to said standing position, and wherein rotating said motor in a second direction, lowers said U-shaped seat-support-panel from said standing position to said sitting position.
